(19) United States
(12) Patent Application Publication
(10) Pub. No.: US 2025/0392354 A1
(43) Pub. Date: Dec. 25, 2025

(54) Reconfigurable Device with Array of Antenna Elements

(71) Applicant: Apple Inc., Cupertino, CA (US)

(72) Inventors: Juan Segador Alvarez, Madrid (ES); Ioannis Sarkas, San Carlos, CA (US); Khan M Salam, Ramona, CA (US); Simone Paulotto, Redwood City, CA (US); Ruben Tena Sanchez, Madrid (ES); Travis A Barbieri, Pacifica, CA (US); Sharad Sambhwani, San Diego, CA (US); Eric L Krenz, Crystal Lake, IL (US)

(21) Appl. No.: 19/238,282

(22) Filed: Jun. 13, 2025

Related U.S. Application Data
(60) Provisional application No. 63/662,844, filed on Jun. 21, 2024.

(51) Int. Cl. H04B 7/04; H01Q 21/06; H04B 7/10

(52) U.S. Cl. CPC H04B 7/04013; H01Q 21/065; H04B 7/10

(57) ABSTRACT

A communication system may include a reconfigurable intelligent surface (RIS) that reflects a radio-frequency signal between first and second devices. The RIS may include an array of antenna elements coupled to adjustable devices. The adjustable devices may configure phase shifts imparted to the radio-frequency signal upon reflection off the RIS. The adjustable devices may include switch modules or may include PIN diodes that are controlled using programmable current sources. The programmable current sources may be disposed within control integrated circuits (ICs) mounted to the periphery of the RIS. Each control IC may control the PIN diodes of a different respective set of the antenna elements. The control ICs may have serial interfaces and may be daisy chained together. The antenna element may be a dual-polarization element with five patches and four diodes in some implementations.

This application claims the benefit of U.S. Provisional Patent Application No. 63/662,844, filed Jun. 21, 2024, which is hereby incorporated by reference herein in its entirety.

### FIELD

This disclosure relates generally to electronic devices, including electronic devices with wireless circuitry.

### BACKGROUND

Electronic devices are often provided with wireless capabilities. An electronic device with wireless capabilities has wireless circuitry that includes one or more antennas. The antennas can be arranged in arrays that convey radio-frequency signals.

As software applications on electronic devices become more data-intensive over time, demand has grown for electronic devices that support wireless communications at higher data rates. However, the maximum data rate supported by electronic devices is limited by the frequency of the radio-frequency signals. As the frequency of the radio-frequency signals increases, it can become increasingly difficult to perform satisfactory wireless communications because the signals become subject to significant over-the-air attenuation and typically require line-of-sight.

### SUMMARY

A communication system may include a reconfigurable intelligent surface (RIS) that reflects a radio-frequency signal between first and second electronic devices. The RIS may include an array of antenna elements. The antenna elements may be coupled to adjustable devices. Control circuitry on the RIS may control the adjustable devices to adjust phase shifts imparted to the radio-frequency signal upon reflection off the RIS. The phase shifts may be selected such that the antenna elements collectively reflect the radio-frequency signal in a selected direction.

In some examples, the adjustable devices may include switch modules. A switch module may have first and second ports coupled to orthogonal edges of an antenna element. The switch module may include additional ports coupled to different radio-frequency paths that load the antenna element to provide different reflected phase shifts to the radio-frequency signal. The switch module may include a first switch that switchably couples the first port to two or more of the additional ports. The switch module may include a second switch that switchably couples the second port to two or more of the additional ports. The states of the first and second switches may be adjusted to change the phase imparted to orthogonal polarizations of the radio-frequency signal upon reflection off the antenna element.

In some examples, the adjustable devices may include PIN diodes that are controlled using programmable current sources. A PIN diode may be coupled between a first edge of an antenna element and a conductor. A DC voltage source may be coupled between the conductor and ground. A programmable current source may be coupled between a second edge of the antenna element and ground. The programmable current sources may be formed within control integrated circuits (ICs) mounted to the periphery of the RIS. Each control IC may control the PIN diodes of a different respective set of the antenna elements. The control ICs may have serial interfaces and may be daisy chained together. In implementations where the antenna element is a dual-polarization element, the antenna element may include a central patch separated from four peripheral patches. Each peripheral patch may be coupled to the central patch by a different respective PIN diode. The peripheral patches may be coupled to one or more of the programmable current sources.

### BRIEF DESCRIPTION OF THE DRAWINGS

FIG. 1 is a schematic block diagram of an illustrative communications system having electronic devices that convey wireless signals via a reconfigurable intelligent surface (RIS) in accordance with some embodiments.

FIG. 2 is a diagram showing how illustrative electronic devices and a RIS may communicate using both a data transfer radio access technology (RAT) and a control RAT in accordance with some embodiments.

FIG. 3 is a circuit schematic diagram of an illustrative RIS that redirects wireless signals in accordance with some embodiments.

FIG. 4 is a schematic diagram of an illustrative antenna unit cell on a RIS that is controlled by a diode and an adjustable current source in accordance with some embodiments.

FIG. 5 is a diagram showing shown an illustrative antenna unit cell of the type shown in FIG. 4 may be integrated into a printed circuit board in accordance with some embodiments.

FIG. 6 is a schematic diagram of an illustrative RIS having an array of antenna elements that are controlled by diodes and adjustable current sources in accordance with some embodiments.

FIG. 7 is a top view of an illustrative RIS having vertically and horizontally polarized antenna elements in different regions of a printed circuit board in accordance with some embodiments.

FIG. 8 is a top view of an illustrative RIS having vertically and horizontally polarized antenna elements that are interleaved with each other on a printed circuit board in accordance with some embodiments.

FIG. 9 is a schematic diagram of an illustrative dual-polarized antenna unit cell on a RIS that is controlled by diodes and adjustable current sources in accordance with some embodiments.

FIG. 10 is a schematic diagram of an illustrative dual-polarized antenna unit cell on a RIS that is controlled using diodes that share adjustable current sources in accordance with some embodiments.

FIG. 11 is a schematic diagram of an illustrative dual-polarized antenna unit cell on a RIS that is controlled using diodes that share a single adjustable current source in accordance with some embodiments.

FIG. 12 is a schematic diagram of an illustrative antenna unit cell on a RIS that is controlled by a switch module in accordance with some embodiments.

FIG. 13 is a cross-sectional side view showing how an illustrative antenna unit cell of the type shown in FIG. 12 may be integrated into a printed circuit board in accordance with some embodiments.

### DETAILED DESCRIPTION

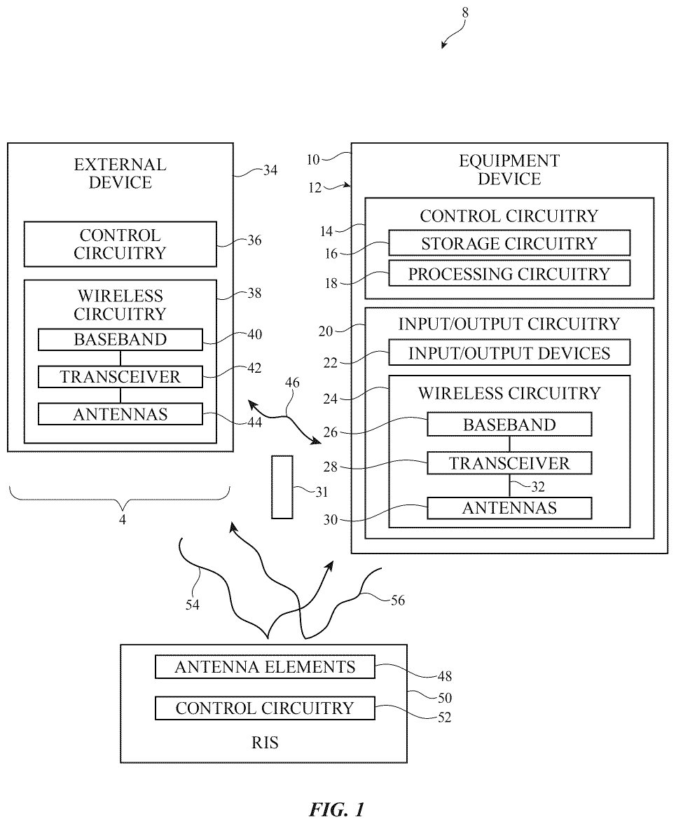

FIG. 1 is a schematic diagram of an illustrative communications system 8 (sometimes referred to herein as communications network 8) for conveying wireless data between communications terminals. Communications system 8 may include network nodes (e.g., communications terminals). The network nodes may include one or more electronic devices such as device 10. The network nodes may also include external communications equipment (e.g., communications equipment other than device 10) such as one or more external devices 34.

Device 10 may be a user equipment (UE) device, a wireless base station, a wireless access point, or other wireless equipment. When implemented as a UE device, device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user's head (e.g., a head-mounted display device such as virtual, augmented, or mixed reality goggles or glasses), or other wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, equipment that implements the functionality of two or more of these devices, or other electronic equipment.

External device 34 may be a UE device, a wireless base station, a wireless access point, or other wireless equipment. In implementations where external device 34 is a UE device, external device 34 may, if desired, be a peripheral or accessory device (e.g., a user input device, a gaming controller, a stylus, a display device, a head-mounted display, headphones, one or more earbuds, a case, etc.) for device 10 (e.g., a cellular telephone, a wristwatch, a head-mounted display, a desktop computer, a tablet computer, a laptop computer, a gaming console, a device integrated into a vehicle, etc.). These examples are illustrative and, in general, external device 34 and device 10 may include any desired wireless communications equipment or other equipment having wireless communications capabilities. Device 10 and external device 34 may communicate with each other using one or more wireless communications links.

As shown in the functional block diagram of FIG. 1, device 10 may include components located on or within an electronic device housing such as housing 12. Housing 12, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 12 may be formed from dielectric or other low-conductivity material (e.g., glass, ceramic, plastic, sapphire, etc.). In other situations, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing communications protocols. Communications protocols that may be implemented using control circuitry 14 include internet protocols, wireless local area network (WLAN) protocols (e.g., IEEE 802.11 protocols-sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), device-to-device (D2D) protocols, peer-to-peer (P2P) protocols, antenna-based spatial ranging protocols, optical communications protocols, ultra-low latency audio protocols, spatial audio protocols, spatial video protocols, or any other desired communications protocols. Each communications protocol may be associated with a corresponding radio access technology (RAT) that specifies the physical connection methodology used in implementing the protocol.

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include wireless circuitry 24 to support wireless communications. Wireless circuitry 24 (sometimes referred to herein as wireless communications circuitry 24) may include baseband circuitry such as baseband circuitry 26 (e.g., one or more baseband processors and/or other circuitry that operates at baseband), radio-frequency (RF) transceiver circuitry such as transceiver 28, and one or more antennas 30. If desired, wireless circuitry 24 may include multiple antennas 30 that are arranged into a phased antenna array (sometimes referred to as a phased array antenna) that conveys radio-frequency signals within a corresponding signal beam that can be steered in different directions. Baseband circuitry 26 may be coupled to transceiver 28 over one or more baseband data paths. Transceiver 28 may be coupled to antennas 30 over one or more radio-frequency transmission line paths 32. If desired, radio-frequency front end circuitry may be disposed on radio-frequency transmission line path(s) 32 between transceiver 28 and antennas 30.

In the example of FIG. 1, wireless circuitry 24 is illustrated as including only a single transceiver 28 and a single radio-frequency transmission line path 32 for the sake of clarity. In general, wireless circuitry 24 may include any desired number of transceivers 28, any desired number of radio-frequency transmission line paths 32, and any desired number of antennas 30. Each transceiver 28 may be coupled to one or more antennas 30 over respective radio-frequency transmission line paths 32. Radio-frequency transmission line path 32 may be coupled to antenna feeds on one or more antenna 30. Each antenna feed may, for example, include a positive antenna feed terminal and a ground antenna feed terminal. Radio-frequency transmission line path 32 may have a positive transmission line signal path that is coupled to the positive antenna feed terminal and may have a ground transmission line signal path that is coupled to the ground antenna feed terminal. This example is merely illustrative and, in general, antennas 30 may be fed using any desired antenna feeding scheme.

Radio-frequency transmission line path 32 may include transmission lines that are used to route radio-frequency antenna signals within device 10. Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Transmission lines in device 10 such as transmission lines in radio-frequency transmission line path 32 may be integrated into rigid and/or flexible printed circuit boards. In one embodiment, radio-frequency transmission line paths such as radio-frequency transmission line path 32 may also include transmission line conductors integrated within multilayer laminated structures (e.g., layers of a conductive material such as copper and a dielectric material such as a resin that are laminated together without intervening adhesive). The multilayer laminated structures may, if desired, be folded or bent in multiple dimensions (e.g., two or three dimensions) and may maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive).

In performing wireless transmission, baseband circuitry 26 may provide baseband signals to transceiver 28 (e.g., baseband signals that include wireless data for transmission). Transceiver 28 may include circuitry for converting the baseband signals received from baseband circuitry 26 into corresponding radio-frequency signals (e.g., for modulating the wireless data onto one or more carriers for transmission, synthesizing a transmit signal, etc.). For example, transceiver 28 may include mixer circuitry for up-converting the baseband signals to radio frequencies prior to transmission over antennas 30. Transceiver 28 may also include digital to analog converter (DAC) and/or analog to digital converter (ADC) circuitry for converting signals between digital and analog domains. Transceiver 28 may transmit the radio-frequency signals over antennas 30 via radio-frequency transmission line path 32. Antennas 30 may transmit the radio-frequency signals to external wireless equipment by radiating the radio-frequency signals into free space.

In performing wireless reception, antennas 30 may receive radio-frequency signals from external device 34. The received radio-frequency signals may be conveyed to transceiver 28 via radio-frequency transmission line path 32. Transceiver 28 may include circuitry for converting the received radio-frequency signals into corresponding baseband signals. For example, transceiver 28 may include mixer circuitry for down-converting the received radio-frequency signals to baseband frequencies prior to conveying the baseband signals to baseband circuitry 26 and may include demodulation circuitry for demodulating wireless data from the received signals.

Front end circuitry disposed on radio-frequency transmission line path 32 may include radio-frequency front end components that operate on radio-frequency signals conveyed over radio-frequency transmission line path 32. If desired, the radio-frequency front end components may be formed within one or more radio-frequency front end modules (FEMs). Each FEM may include a common substrate such as a printed circuit board substrate for each of the radio-frequency front end components in the FEM. The radio-frequency front end components in the front end circuitry may include switching circuitry (e.g., one or more radio-frequency switches), radio-frequency filter circuitry (e.g., low pass filters, high pass filters, notch filters, band pass filters, multiplexing circuitry, duplexer circuitry, diplexer circuitry, triplexer circuitry, etc.), impedance matching circuitry (e.g., circuitry that helps to match the impedance of antennas 30 to the impedance of radio-frequency transmission line path 32), antenna tuning circuitry (e.g., networks of capacitors, resistors, inductors, and/or switches that adjust the frequency response of antennas 30), radio-frequency amplifier circuitry (e.g., power amplifier circuitry and/or low-noise amplifier circuitry), radio-frequency coupler circuitry, charge pump circuitry, power management circuitry, digital control and interface circuitry, and/or any other desired circuitry that operates on the radio-frequency signals transmitted and/or received by antennas 30.

While control circuitry 14 is shown separately from wireless circuitry 24 in the example of FIG. 1 for the sake of clarity, wireless circuitry 24 may include processing circuitry that forms a part of processing circuitry 18 and/or storage circuitry that forms a part of storage circuitry 16 of control circuitry 14 (e.g., portions of control circuitry 14 may be implemented on wireless circuitry 24). As an example, baseband circuitry 26 and/or portions of transceiver 28 (e.g., a host processor on transceiver 28) may form a part of control circuitry 14. Baseband circuitry 26 may, for example, access a communication protocol stack on control circuitry 14 (e.g., storage circuitry 16) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

The term “convey wireless signals” as used herein means the transmission and/or reception of the wireless signals (e.g., for performing unidirectional and/or bidirectional wireless communications with external wireless communications equipment). Antennas 30 may transmit the wireless signals by radiating the signals into free space (or to free space through intervening device structures such as a dielectric cover layer). Antennas 30 may additionally or alternatively receive the wireless signals from free space (e.g., through intervening devices structures such as a dielectric cover layer). The transmission and reception of wireless signals by antennas 30 each involve the excitation or resonance of antenna currents on an antenna resonating (radiating) element in the antenna by the wireless signals within the frequency band(s) of operation of the antenna.

Transceiver circuitry 28 may use antenna(s) 30 to transmit and/or receive wireless signals that convey wireless communications data between device 10 and external device 34. The wireless communications data may be conveyed bidirectionally or unidirectionally. The wireless communications data may, for example, include data that has been encoded into corresponding data packets such as wireless data associated with a telephone call, streaming media content, internet browsing, wireless data associated with software applications running on device 10, email messages, etc.

Additionally or alternatively, wireless circuitry 24 may use antenna(s) 30 to perform wireless (radio-frequency) sensing operations. The sensing operations may allow device 10 to detect (e.g., sense or identify) the presence, location, orientation, and/or velocity (motion) of objects external to device 10. Control circuitry 14 may use the detected presence, location, orientation, and/or velocity of the external objects to perform any desired device operations. As examples, control circuitry 14 may use the detected presence, location, orientation, and/or velocity of the external objects to identify a corresponding user input for one or more software applications running on device 10 such as a gesture input performed by the user's hand(s) or other body parts or performed by an external stylus, gaming controller, head-mounted device, or other peripheral devices or accessories, to determine when one or more antennas 30 needs to be disabled or provided with a reduced maximum transmit power level (e.g., for satisfying regulatory limits on radio-frequency exposure), to determine how to steer (form) a radio-frequency signal beam produced by antennas 30 for wireless circuitry 24 (e.g., in scenarios where antennas 30 include a phased array of antennas 30), to map or model the environment around device 10 (e.g., to produce a software model of the room where device 10 is located for use by an augmented reality application, gaming application, map application, home design application, engineering application, etc.), to detect the presence of obstacles in the vicinity of (e.g., around) device 10 or in the direction of motion of the user of device 10, etc. The sensing operations may, for example, involve the transmission of sensing signals (e.g., radar waveforms), the receipt of corresponding reflected signals (e.g., the transmitted waveforms that have reflected off of external objects), and the processing of the transmitted signals and the received reflected signals (e.g., using a radar scheme).

Wireless circuitry 24 may transmit and/or receive wireless signals within corresponding frequency bands of the electromagnetic spectrum (sometimes referred to herein as communications bands or simply as “bands”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHZ), a Wi-Fi® 6E band (e.g., from 5925-7125 MHZ), and/or other Wi-Fi® bands (e.g., from 1875-5160 MHZ), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands at sub-THz or THz frequencies greater than about 100 GHz, etc.), other centimeter or millimeter wave frequency bands between 10-100 GHz, near-field communications frequency bands (e.g., at 13.56 MHZ), satellite navigation frequency bands (e.g., a GPS band from 1565 to 1610 MHz, a Global Navigation Satellite System (GLONASS) band, a BeiDou Navigation Satellite System (BDS) band, etc.), D2D bands, ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

Over time, software applications on electronic devices such as device 10 have become more and more data intensive. Wireless circuitry on the electronic devices therefore needs to support data transfer at higher and higher data rates. In general, the data rates supported by the wireless circuitry are proportional to the frequency of the wireless signals conveyed by the wireless circuitry (e.g., higher frequencies can support higher data rates than lower frequencies). Wireless circuitry 24 may convey centimeter and millimeter wave signals to support relatively high data rates (e.g., because centimeter and millimeter wave signals are at relatively high frequencies between around 10 GHz and 100 GHz). However, the data rates supported by centimeter and millimeter wave signals may still be insufficient to meet all the data transfer needs of device 10. To support even higher data rates such as data rates up to 5-100 Gbps or higher, wireless circuitry 24 may convey wireless signals at frequencies greater than about 100 GHz.

As shown in FIG. 1, wireless circuitry 24 may transmit wireless signals 46 to external device 34 and/or may receive wireless signals 46 from external device 34. Wireless signals 46 may be tremendously high frequency (THF) signals (e.g., sub-THz or THz signals) at frequencies greater than or equal to around 100 GHz (e.g., between 100 GHz and 1 THz, between 80 GHz and 10 THz, between 100 GHz and 10 THz, between 100 GHz and 2 THz, between 200 GHz and 1 THz, between 300 GHz and 1 THz, between 300 GHz and 2 THz, between 70 GHz and 2 THz, between 300 GHz and 10 THz, between 100 GHz and 800 GHZ, between 200 GHz and 1.5 THz, or within any desired sub-THz, THz, THF, or sub-millimeter frequency band such as a 6G frequency band), may be millimeter (mm) or centimeter (cm) wave signals between 10 GHz and around 70 GHz (e.g., 5G NR FR2 signals), or may be signals at frequencies less than 10 GHz (e.g., 5G NR FR1 signals, LTE signals, 3G signals, 2G signals, WLAN signals, Bluetooth signals, UWB signals, etc.). When transmitting wireless signals 46, device 10 is sometimes also referred to herein as a transmitter device, a transmit (TX) device, or a transmitter. When receiving wireless signals 46, device 10 is sometimes referred to herein as a receiver device, a receive (RX) device, or a receiver.

If desired, the high data rates supported by wireless signals 46 may be leveraged by device 10 to perform cellular telephone voice and/or data communications (e.g., while supporting spatial multiplexing to provide further data bandwidth), to perform spatial ranging operations such as radar operations to detect the presence, location, and/or velocity of objects external to device 10, to perform automotive sensing (e.g., with enhanced security), to perform health/body monitoring on a user of device 10 or another person, to perform gas or chemical detection, to form a high data rate wireless connection between device 10 and another device or peripheral device (e.g., to form a high data rate video link between a display driver on device 10 and a display that displays ultra-high resolution video, to form a high data rate video link between a display driver on another device and a display on device 10 that displays ultra-high resolution video, to form a high data rate audio link between an audio driver on device 10 and wireless headphones or earbuds that output high fidelity spatial audio, to form a high data rate audio link between an audio driver on another device and speakers on device 10, etc.), to form a remote radio head (e.g., a flexible high data rate connection), to form a THF chip-to-chip connection within device 10 that supports high data rates (e.g., where one antenna 30 on a first chip in device 10 transmits THF signals 32 to another antenna 30 on a second chip in device 10), and/or to perform any other desired high data rate operations.

In implementations where wireless circuitry 24 conveys wireless signals 46, the wireless circuitry may include electro-optical circuitry if desired. The electro-optical circuitry may include light sources that generate first and second optical local oscillator (LO) signals. The first and second optical LO signals may be separated in frequency by the intended frequency of wireless signals 46. Wireless data may be modulated onto the first optical LO signal and one of the optical LO signals may be provided with an optical phase shift (e.g., to perform beamforming). The first and second optical LO signals may illuminate a photodiode that produces current at the frequency of wireless signals 46 when illuminated by the first and second optical LO signals. An antenna resonating element of a corresponding antenna 30 may convey the current produced by the photodiode and may radiate corresponding wireless signals 46. This is merely illustrative and, in general, wireless circuitry 24 may generate wireless signals 46 using any desired techniques.

Antennas 30 may be formed using any desired antenna structures. For example, antennas 30 may include antennas with resonating elements that are formed from loop antenna structures, patch antenna structures, inverted-F antenna structures, slot antenna structures, planar inverted-F antenna structures, helical antenna structures, monopole antennas, dipoles (e.g., planar dipole antennas such as bowtie antennas), hybrids of these designs, etc. Parasitic elements may be included in antennas 30 to adjust antenna performance.

If desired, two or more of antennas 30 may be integrated into a phased antenna array (sometimes referred to herein as a phased array antenna or an array of antenna elements). Each antenna 30 in the phased antenna array forms a respective antenna element of the phased antenna array. Each antenna 30 in the phased antenna array has a respective phase and magnitude controller that imparts the radio-frequency signals conveyed by that antenna with a respective phase and magnitude. The respective phases and magnitudes may be selected (e.g., by control circuitry 14) to configure the radio-frequency signals conveyed by the antennas 30 in the phased antenna array to constructively and destructively interfere in such a way that the radio-frequency signals collectively form a signal beam (e.g., a signal beam of wireless signals 46) oriented in a corresponding beam pointing direction (e.g., a direction of peak gain).

The control circuitry may adjust the phases and magnitudes to change (steer) the orientation of the signal beam (e.g., the beam pointing direction) to point in other directions over time. This process may sometimes also be referred to herein as beamforming. Beamforming may boost the gain of wireless signals 46 to help overcome over-the-air attenuation and the signal beam may be steered over time to point towards external device 34 even as the position and orientation of device 10 changes. The signal beams formed by antennas 30 of device 10 may sometimes be referred to herein as device beams, UE beams, or device signal beams. Each UE beam may be oriented in a different respective direction (e.g., a beam pointing direction of peak signal gain) as defined by corresponding phase and/or magnitude settings of the phase antenna array. Each UE beam may be labeled by a corresponding UE beam index. Device 10 may include or store a codebook that maps each of its UE beam indices to the corresponding phase and magnitude settings for each antenna 30 in a phased antenna array that configure the phased antenna array to form the UE beam associated with that UE beam index.

As shown in FIG. 1, external device 34 may also include control circuitry 36 (e.g., control circuitry having similar components and/or functionality as control circuitry 14 in device 10) and wireless circuitry 38 (e.g., wireless circuitry having similar components and/or functionality as wireless circuitry 24 in device 10). If desired, external device 34 may include input/output devices (not shown in FIG. 1 for the sake of clarity) such as input/output devices 22 of device 10. Wireless circuitry 38 may include baseband circuitry 40 and transceiver 42 (e.g., transceiver circuitry having similar components and/or functionality as transceiver circuitry 28 in device 10) coupled to two or more antennas 44 (e.g., antennas having similar components and/or functionality as antennas 30 in device 10). Antennas 44 may be arranged in one or more phased antenna arrays (e.g., phased antenna arrays that perform beamforming similar to phased antenna arrays of antennas 30 on device 10).

External device 34 may use wireless circuitry 38 to transmit a signal beam of wireless signals 46 to device 10 and/or to receive a signal beam of wireless signals 46 transmitted by device 10. The signal beams formed by antennas 44 of external device 34 may sometimes be referred to herein as external device beams, external device signal beams. Each external device signal beam may be oriented in a different respective direction (e.g., a beam pointing direction of peak signal gain) as defined by the corresponding phase and magnitude settings of the phased antenna array. Each external device signal beam may be labeled by a corresponding external device beam index. External device 34 may include or store a codebook that maps each of its external device signal beam indices to the corresponding phase and magnitude settings for each antenna 44 in a phased antenna array that configure the phased antenna array to form the external device signal beam associated with that external device signal beam index.

While communications at high frequencies allow for extremely high data rates (e.g., greater than 100 Gbps), wireless signals 46 at such high frequencies are subject to significant attenuation during propagation over-the-air. Integrating antennas 30 and 44 into phased antenna arrays helps to counteract this attenuation by boosting the gain of the signals within a signal beam. However, signal beams are highly directive and may require a line-of-sight (LOS) to support a satisfactory wireless link between device 10 and external device 34. If an external object is present between external device 34 and device 10, the external object may block the LOS between device 10 and external device 34, which can disrupt wireless communications using wireless signals 46. If desired, a reflective device such as a reconfigurable intelligent surface (RIS) may be used to allow device 10 and external device 34 to continue to communicate using wireless signals 46 even when an external object blocks the LOS between device 10 and external device 34 (or whenever direct over-the-air communications between external device 34 and device 10 otherwise exhibits less than optimal performance).

As shown in FIG. 1, system 8 may include one or more reconfigurable intelligent surfaces (RIS's) such as RIS 50. RIS 50 may sometimes also be referred to as an intelligent reconfigurable surface (IRS), an intelligent reflective/reflecting surface, a reflective intelligent surface, a reflective surface, a reflective device, a reconfigurable reflective device, a reconfigurable reflective surface, or a reconfigurable surface. External device 34 may be separated from device 10 by a line-of-sight (LOS) path. In some circumstances, an external object such as object 31 may block the LOS path. Object 31 may be, for example, part of a building such as a wall, window, floor, or ceiling (e.g., when device 10 is located inside), furniture, a body or body part, an animal, a cubicle wall, a vehicle, a landscape feature, or other obstacles or objects that may block the LOS path between external device 34 and device 10.

In the absence of external object 31, external device 34 may form a corresponding external device signal beam of wireless signals 46 oriented in the direction of device 10 and device 10 may form a corresponding UE beam of wireless signals 46 oriented in the direction of external device 34. Device 10 and external device 34 can then convey wireless signals 46 over their respective signal beams and the LOS path. However, the presence of external object 31 prevents wireless signals 46 from being conveyed over the LOS path.

RIS 50 may be placed or disposed within system 8 so as to allow RIS 50 to redirect (e.g., reflect) wireless signals 46 between device 10 and external device 34 despite the presence of external object 31 within the LOS path. More generally, RIS 50 may be used to reflect wireless signals 46 between device 10 and external device 34 when reflection via RIS 50 offers superior radio-frequency propagation conditions relative to the LOS path regardless of the presence of external object 31 (e.g., when the LOS path between external device 34 and RIS 50 and the LOS path between RIS 50 and device 10 exhibit superior propagation/channel conditions than the direct LOS path between device 10 and external device 34). While RIS 50 may additionally or alternatively redirect wireless signals 46 in different directions via transmission through RIS 50 (e.g., by imparting different phases to incident wireless signals 46 that are redirected, via passive transmission, by RIS 50 within the hemisphere opposite to that which the RIS received the signals, as if the RIS were transparent to the signals), implementations in which RIS 50 reflects wireless signals 46 between device 10 and external device 34 are illustrated and described herein as an example for the sake of simplicity and conciseness.

When RIS 50 is placed within system 8, external device 34 may transmit wireless signals 46 towards RIS 50 (e.g., within a external device signal beam oriented towards RIS 50 rather than towards device 10) and RIS 50 may reflect the wireless signals towards device 10, as shown by arrow 54. Conversely, device 10 may transmit wireless signals 46 towards RIS 50 (e.g., within a UE beam oriented towards RIS 50 rather than towards external device 34) and RIS 50 may reflect the wireless signals towards external device 34, as shown by arrow 56.

RIS 50 is an electronic device that includes a one or two-dimensional surface of engineered material having reconfigurable properties for performing (e.g., reflecting) communications between external device 34 and device 10. RIS 50 may include an array of reflective elements such as antenna elements 48 on an underlying substrate. Antenna elements 48 may also sometimes be referred to herein as reflective elements 48, reconfigurable antenna elements 48, reconfigurable reflective elements 48, reflectors 48, reconfigurable reflectors 48, reflective antennas 48, passive antennas 48, or passive antenna elements 48.

Antenna elements 48 may be arranged in a one-dimensional array or a two-dimensional array pattern on RIS 50. When implemented in a one-dimensional array, antenna elements 48 may be arranged linearly (e.g., as Uniform Linear Array (ULA)), circularly (e.g., as a circular array), or along a linear manifold. When implemented in a two-dimensional array (e.g., as a Uniform Planar Array (UPA)), antenna elements 48 may be arranged in a plane, in a curved surface (e.g., on a dome to obtain more omni-directional coverage), or in any two-dimensional manifold. If desired, antenna elements 48 may even be arranged three dimensionally (e.g., on the vertices of a 3D lattice structure). Similarly, device 10 may include a phased antenna array of antennas 30 arranged in a one-dimensional array (e.g., as a ULA), in a two-dimensional array (e.g., as a UPA), in a three-dimensional array or in any other desired pattern. Likewise, external device 34 may include a phased array of antennas 44 arranged in a one-dimensional array (e.g., as a ULA), in a two-dimensional array (e.g., as a UPA), in a three-dimensional array or in any other desired pattern.

The substrate of RIS 50 may be a rigid or flexible printed circuit board, a package, a plastic substrate, meta-material, a semiconductor (e.g., silicon) substrate, a ceramic substrate, or any other desired substrate. The substrate may be planar or may be curved in one or more dimensions. If desired, the substrate and antenna elements 48 may be enclosed within a housing. The housing may be formed from materials that are transparent to wireless signals 46. If desired, RIS 50 may be disposed (e.g., layered) on an underlying electronic device. RIS 50 may also be provided with mounting structures (e.g., adhesive, brackets, a frame, screws, pins, clips, etc.) that can be used to affix or attach RIS 50 to an underlying structure such as another electronic device, a wall, the ceiling, the floor, furniture, etc. Disposing RIS 50 on a ceiling, wall, window, column, pillar, or at or adjacent to the corner of a room (e.g., a corner where two walls intersect, where a wall intersects with the floor or ceiling, where two walls and the floor intersect, or where two walls and the ceiling intersect), as examples, may be particularly helpful in allowing RIS 50 to reflect wireless signals between external device 34 and device 10 around various objects 31 that may be present (e.g., when external device 34 is located outside and device 10 is located inside, when external device 34 and device 10 are both located inside or outside, etc.).

RIS 50 may be a passive adaptively controlled reflecting surface and a powered device that includes control circuitry 52. Control circuitry 52 (e.g., one or more processors on RIS 50 such as the one or more processors in processing circuitry 18 of device 10) may help to control the operation of antenna elements 48 on RIS 50. When electro-magnetic (EM) energy waves (e.g., waves of wireless signals 46) are incident on RIS 50, the wave is reflected by each antenna element 48 via re-radiation by each antenna element 48 with a respective phase and amplitude response. The combination of the phase and amplitude responses imparted to the reflected wave across the array of antenna elements 48 may collectively cause wireless signals 46 to reflect from an incident angle (or range of incident angles) onto a particular output (e.g., reflected) angle.

Antenna elements 48 may include passive reflectors (e.g., antenna resonating elements or other radio-frequency reflective elements). In implementations where RIS 50 is transmissive, antenna elements 48 may include passive elements that redirect signals in a transmissive mode. Each antenna element 48 may be coupled to a respective adjustable device that is programmed, set, and/or controlled by control circuitry 52 (e.g., using a control signal that includes or represents a respective beamforming coefficient) to configure that antenna element 48 to reflect incident EM energy with a respective phase and amplitude response (e.g., with a respective reflection coefficient). The adjustable device may be a diode with adjustable current source, a switch module, a photodiode, an adjustable impedance matching circuit, an adjustable phase shifter, an adjustable amplifier, a varactor diode, an antenna tuning circuit, combinations of these, etc. Implementations in which the adjustable device is a PIN diode with adjustable current source or a switch module may serve to minimize power consumption and cost on RIS 50 (e.g., allowing the number of antenna elements 48 on RIS 50 to be scaled up without incurring excessive cost) and are described herein as an example.

Control circuitry 52 on RIS 50 may configure the reflective response of antenna elements 48 on a per-element or per-group-of-elements basis (e.g., where each antenna element has a respective programmed phase and amplitude response or the antenna elements in different sets/groups of antenna elements are each programmed to share the same respective phase and amplitude response across the set/group but with different phase and amplitude responses between sets/groups). The scattering, absorption, reflection, transmission, and diffraction properties of the entire RIS can therefore be changed over time and controlled (e.g., by software running on the RIS or other devices communicably coupled to the RIS such as external device 34 or device 10).

One way of achieving the per-element phase and amplitude response of antenna elements 48 is by adjusting the impedance of antenna elements 48, thereby controlling the complex reflection coefficient that determines the change in amplitude and phase of the re-radiated signal. The control circuitry 52 on RIS 50 may configure antenna elements 48 to exhibit impedances that serve to reflect wireless signals 46 incident from particular incident angles onto particular output angles. The antenna elements 48 (e.g., the antenna impedances) may be adjusted to change the angle with which incident wireless signals 46 are reflected off of RIS 50.

For example, the control circuitry on RIS 50 may configure antenna elements 48 to reflect wireless signals 46 transmitted by external device 34 towards device 10 (as shown by arrow 54) and to reflect wireless signals 46 transmitted by device 10 towards external device 34 (as shown by arrow 56). In such an example, control circuitry 36 may configure (e.g., program) a phased antenna array of antennas 44 on external device 34 to form an external device signal beam oriented towards RIS 50, control circuitry 14 may configure (e.g., program) a phased antenna array of antennas 30 on device 10 to form a UE beam oriented towards RIS 50, control circuitry 52 may configure (e.g., program) antenna elements 48 to receive and re-radiate (e.g., effectively redirect via reflection or, alternatively, transmission) the wireless signals incident from the direction of external device 34 towards/onto the direction of device 10 (as shown by arrow 54), and control circuitry 52 may configure (e.g., program) antenna elements 48 to receive and re-radiate (e.g., effectively redirect via reflection or, alternatively, transmission) the wireless signals incident from the direction of device 10 towards/onto the direction of external device 34 (as shown by arrow 56). Control circuitry 52 on RIS 50 may set and adjust the adjustable devices coupled to antenna elements 48 (e.g., may set and adjust the impedances of antenna elements 48) over time to reflect wireless signals 46 incident from different selected incident angles onto different selected output angles.

To minimize the cost, complexity, and power consumption of RIS 50, RIS 50 may include only the components and control circuitry required to control and operate antenna elements 48 to reflect wireless signals 46. Such components and control circuitry may include, for example, the adjustable devices for antenna elements 48 as required to change the phase and magnitude responses of antenna elements 48 and thus the direction with which RIS 50 reflects wireless signals 46. The components may include, for example, components that adjust the impedances of antenna elements 48 so that each antenna element exhibits a respective complex reflection coefficient, which determines the phase and amplitude of the reflected (re-radiated) signal produced by each antenna element (e.g., such that the signals reflected across the array constructively and destructively interfere to form a reflected signal beam in a corresponding beam pointing direction).

All other components that would otherwise be present in device 10 or external device 34 may be omitted from RIS 50. For example, RIS 50 may be free from baseband circuitry (e.g., baseband circuitry 26 or 40) and/or transceiver circuitry (e.g., transceiver 42 or 28) coupled to antenna elements 48. Antenna elements 48 and RIS 50 may therefore be incapable of generating wireless data for transmission, synthesizing radio-frequency signals for transmission, and/or receiving and demodulating incident radio-frequency signals. RIS 50 may also be implemented without a display or user input device. In other words, the control circuitry on RIS 50 may adjust antenna elements 48 to direct and steer reflected wireless signals 46 without using antenna elements 48 to perform any data transmission or reception operations and without using antenna elements 48 to perform radio-frequency sensing operations. In other implementations, the RIS may include some active circuitry such as circuitry for demodulating received signals using the data RAT (e.g., to perform channel estimates for optimizing its reflection coefficients).

This may serve to minimize the hardware cost and power consumption of RIS 50. If desired, RIS 50 may also include one or more antennas (e.g., antennas separate from the antenna elements 48 used to reflect wireless signals 46) and corresponding transceiver/baseband circuitry that uses the one or more antennas to convey control signals with external device 34 or device 10 (e.g., using a control channel plane and control RAT). Such control signals may be used to coordinate the operation of RIS 50 in conjunction with external device 34 and/or device 10 but requires much lower data rates and thus much fewer processing resources and much less power than transmitting or receiving wireless signals 46. These control signals may, for example, be transmitted by device 10 and/or external device 34 to configure the phase and magnitude responses of antenna elements 48 (e.g., the control signals may convey beamforming coefficients). This may, for example, allow the calculation of phase and magnitude responses for antenna elements 48 to be offloaded from RIS 50, further reducing the processing resources and power required by RIS 50. In other implementations, RIS 50 may be a self-controlled RIS that includes processing circuitry for generating its own phase and magnitude responses and/or for coordinating communications among multiple devices (e.g., in a RIS-as-a-service configuration).

In this way, RIS 50 may help to relay wireless signals 46 between external device 34 and device 10 when object 31 blocks the LOS path between external device 34 and device 10 and/or when the propagation conditions from external device 34 to RIS 50 and from RIS 50 to device 10 are otherwise superior to the propagation conditions from external device 34 to device 10. At the same time, RIS 50 may include only the processing resources and may consume only the power required to perform control procedures, minimizing the cost of RIS 50 and maximizing the flexibility with which RIS 50 can be placed within the environment.

RIS 50 may include or store a codebook (sometimes referred to herein as a RIS codebook) that maps settings for antenna elements 48 to different reflected signal beams formable by antenna elements 48 (sometimes referred to herein as RIS beams). RIS 50 may configure its own antenna elements 48 to perform beamforming with respective beamforming coefficients (e.g., as given by the RIS codebook). In general, RIS 50 may relay signals between two or more different devices or may reflect signals transmitted by a single device back to that device.

The example of FIG. 1 is illustrative and non-limiting. If desired, communications system 8 may include multiple RIS's 50. If desired, a chain or series of multiple RIS's 50 at different locations may be used to relay wireless signals 46 between external device 34 and device 10 (e.g., using a sequence of reflections or hops between the RIS's). If desired, communications system 8 may include multiple devices 10 (e.g., UE devices) that convey wireless signals 46 with external device 34 (e.g., a BS) directly and/or via one or more RIS's 50. If desired, communications system 8 may include multiple external devices 34 (e.g., base stations) disposed at different locations (e.g., within respective cells of a cellular telephone network).

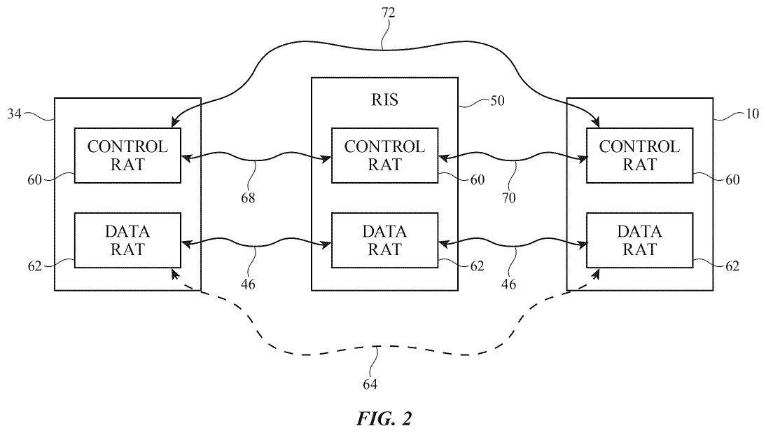

FIG. 2 is a diagram showing how external device 34, RIS 50, and device 10 may communicate using both a control RAT and a data transfer RAT for establishing and maintaining communications between external device 34 and device 10 via RIS 50. As shown in FIG. 2, external device 34, RIS 50, and device 10 may each include wireless circuitry that operates according to a data transfer RAT 62 (sometimes referred to herein as data RAT 62) and a control RAT 60. Data RAT 62 may be a RAT that performs wireless communications at the frequencies of wireless signals 46 (e.g., a millimeter/centimeter wave RAT, a 5G NR FR2 RAT, a sub-THz or 6G RAT, etc.). Control RAT 60 may be associated with wireless communications that consume much fewer resources and are less expensive to implement than the communications of data RAT 62. For example, control RAT 60 may be Wi-Fi, Bluetooth, a cellular telephone RAT such as a 3G, 4G, or 5G NR FR1 RAT, etc. As another example control RAT 60 may be an infrared communications RAT (e.g., where an infrared remote control or infrared emitters and sensors use infrared light to convey signals for the control RAT between device 10, external device 34, and/or RIS 50).

External device 34 and RIS 50 may use control RAT 60 to convey radio-frequency signals 68 (e.g., control signals) between external device 34 and RIS 50. Device 10 and RIS 50 may use control RAT 60 to convey radio-frequency signals 70 (e.g., control signals) between device 10 and RIS 50. Device 10, external device 34, and RIS 50 may use data RAT 62 to convey wireless signals 46 via reflection off antenna elements 48 of RIS 50. The wireless signals may be reflected by RIS 50 between external device 34 and device 10. External device 34 may use radio-frequency signals 68 and control RAT 60 and/or device 10 may use radio-frequency signals 70 and control RAT 60 to discover RIS 50 and to configure antenna elements 48 to establish and maintain the relay of wireless signals 46 performed by antenna elements 48 using data RAT 62.

If desired, external device 34 and device 10 may also use control RAT 60 to convey radio-frequency signals 72 directly with each other (e.g., since the control RAT operates at lower frequencies that do not require line-of-sight). Device 10 and external device 34 may use radio-frequency signals 72 to help establish and maintain data RAT communications between device 10 and external device 34 via RIS 50. External device 34 and device 10 may also use data RAT 62 to convey wireless signals 46 directly (e.g., without reflection off RIS 50) when a LOS path is available (as shown by path 64). RIS 50 need not be wirelessly controlled and may, if desired, be controlled, configured, and/or reconfigured manually or using a wired path (e.g., support for control RAT 60 may be omitted from RIS 50).

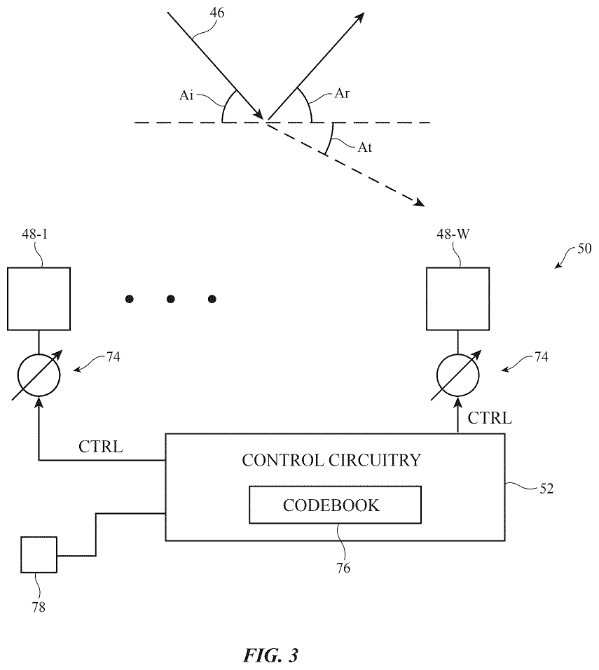

FIG. 3 is a schematic diagram of RIS 50. As shown in FIG. 3, RIS 50 may include a set of W antenna elements 48 (e.g., a first antenna element 48-1, a Wth antenna element 48-W, etc.). W may be any desired integer greater than or equal to two (e.g., four, eight, sixteen, 32, 64, 128, 256, more than 10, more than 20, more than 50, more than 100, more than 500, 4-128, 8-500, etc.). Antenna elements 48 may include patches, monopoles, dipoles, bowties (e.g., dipoles having non-constant width), inverted-F elements, planar inverted-F elements, slots, or other structures formed from metal or metamaterials/metastructures on an underlying substrate.

The W antenna elements 48 on RIS 50 may be arranged in an array pattern. The antenna elements may have sub-wavelength spacing and may each have a sub-wavelength width/size. The array pattern may have a grid of rows and columns. Other array patterns may be used if desired. Each antenna element 48 may be coupled to a corresponding adjustable device 74. Adjustable devices 74 may include diodes with adjustable current sources or may include switch modules, as two examples. Each adjustable device 74 and its corresponding antenna element 48 are sometimes referred to collectively herein as a unit cell or antenna unit cell of RIS 50 (e.g., RIS 50 may have an array of W unit cells).

Control circuitry 52 may provide control signals CTRL to adjustable devices 74 that configure each adjustable device 74 to impart a selected impedance to its corresponding antenna element 48. The impedance may effectively impart a corresponding phase shift to incident wireless signals 46 that are scattered (e.g., re-radiated or effectively reflected) by the antenna element. Adjustable devices 74 are therefore sometimes be referred to herein as phase shifters 74, reflective phase shifters 74, or effective phase shifters 74.

Control circuitry 52 may transmit control signals CTRL to adjustable devices 74 to control each adjustable device 74 to exhibit a corresponding impedance or reflection coefficient. Each impedance or reflection coefficient may cause the corresponding antenna element 48 to impart a particular phase shift to the wireless signals 46 scattered (reflected) by the antenna element for data RAT 62 (FIG. 2). By selecting appropriate settings for adjustable devices 74, the array of W antenna elements 48 may be configured to collectively reflect wireless signals 46 in a particular direction.

For example, the array of W antenna elements 48 may be configured to redirect wireless signals incident from an angle-of-arrival (AOA) Ai onto a corresponding angle-of-departure (AOD) Ar (sometimes also referred to herein as reflection angle Ar). Implementations in which RIS 50 reflects wireless signals 46 are described herein as an example. RIS 50 may equivalently transmit wireless signals 46 incident from AOA Ai onto a corresponding transmitted angle At (e.g., where the substate of RIS 50 is substantially transparent to wireless signals 46 and the phase shifts produced by antenna elements 48 cause wireless signals 46 to be transmitted by RIS 50 at transmitted angle At).

As shown in FIG. 3, RIS 50 may have one or more antennas 78. Antenna(s) 78 may include one or more of the W antenna elements 48 or may be separate from the W antenna elements 48 on RIS 50. Antenna(s) 78 may be coupled to a control RAT transceiver on RIS 50 and may be used to convey control signals over control RAT 60. Control circuitry 52 may transmit control signals using antenna(s) 78 and/or may receive control signals using antenna(s) 78. Antenna(s) 78 may be omitted if desired.

Control circuitry 52 may store a codebook 76 that maps different sets of settings for adjustable devices 74 to different input/output angles. Codebook 76 may be populated during manufacture, deployment, calibration, and/or regular operation of RIS 50. Codebook 76 may be stored on storage circuitry or memory on RIS 50. If desired, external device 34, device 10, or a dedicated controller may use control RAT 60 to populate and/or update the entries of codebook 76.

RIS 50 may dynamically change the impedances (e.g., phase settings or reflection coefficients) of antenna elements 48 over time (e.g., to direct reflected signals in different directions to serve one or more external devices 34 as the position of the external device(s) and/or device 10 changes over time). If desired, RIS 50 may be at least partially controlled by a remote controller located on an external device other than RIS 50. The remote controller may be located on an electronic device such as external device 34, device 10, a dedicated RIS controller, and/or other nodes of system 8 (FIG. 1). The remote controller may be distributed across multiple devices or network nodes if desired. Alternatively, RIS 50 may be entirely controlled by a local controller in control circuitry 52.

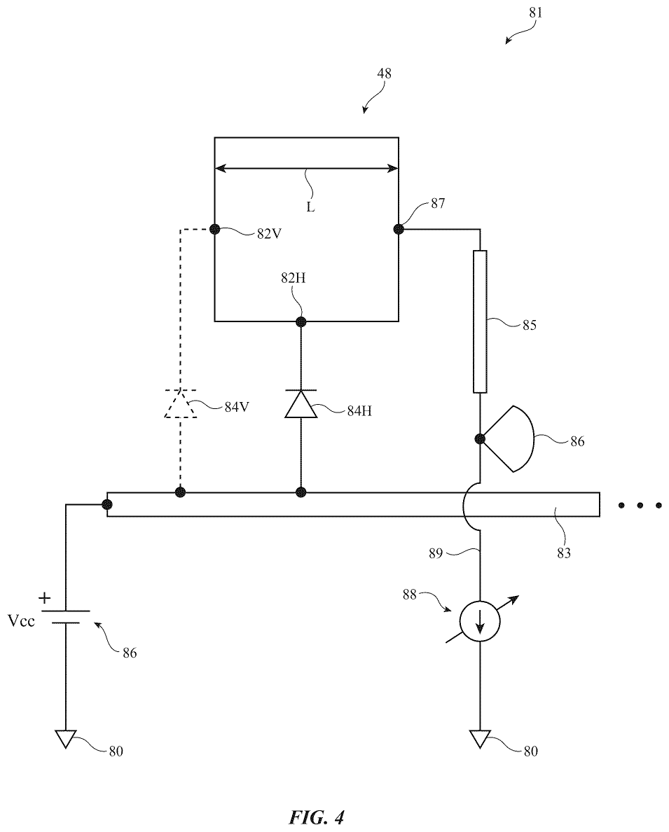

FIG. 4 is a schematic diagram of an illustrative unit cell 81 on RIS 50, in implementations where the unit cell is controlled by an adjustable device 74 that includes a diode and an adjustable current source. As shown in FIG. 4, unit cell 81 may include a corresponding antenna element 48 (illustrated as a patch element in FIG. 4 for the sake of simplicity), a DC voltage source 86, and a conductor 83.

Antenna element 48 may have a lateral dimension such as length L. Length L may be selected to configure antenna element 48 to redirect (reflect) radio-frequency signals at the frequencies of wireless signals 46. Length L may, for example, be approximately equal to half the effective wavelength corresponding to a frequency of wireless signals 46 (e.g., where effective wavelength is equal to free space wavelength multiplied by a constant given by the dielectric properties of RIS 50). In the example of FIG. 4, antenna element 48 is rectangular (e.g., square). This is illustrative and non-limiting. In general, antenna element 48 may have any desired number of straight and/or curved edges. Antenna element 48 may be implemented using other antenna architectures (e.g., a monopole arm, dipole arms, bowtie arms, slots, inverted-F elements, planar inverted-F elements, loop elements, etc.).

Since antenna element 48 is a passive reflector/radiator, antenna element 48 is not fed using a radio-frequency transmission line. Instead, a first terminal 82H along a first edge of antenna element 48 may be coupled to conductor 83 by diode 84H (e.g., a PIN diode). The cathode of diode 84H may be coupled to terminal 82H. The anode of diode 84H may be coupled to conductor 83. DC voltage source 86 may be coupled between conductor 83 and a reference (ground) potential such as ground 80. DC voltage source 86 may form a DC voltage V_{cc} between conductor 83 and ground 80. This may configure conductor 83 to form part of a ground plane for antenna element 48 and RIS 50 while concurrently forming a power plane for PIN diode 84H.

Conductor 83 may be formed from one or more conductive traces or other conductive structures in RIS 50. Antenna element 48 may overlap conductor 83 (e.g., on the substrate of RIS 50, which has been omitted from FIG. 4 for the sake of clarity). Conductor 83 may sometimes also be referred to herein as antenna ground 83, antenna ground conductor 83, antenna ground plane 83, ground plane 83, antenna ground trace 83, ground trace 83, diode power conductor 83, diode power trace 83, or diode power plane 83. Conductor 83 and DC voltage source 86 may, if desired, be shared by each of the W antenna elements 48 (e.g., each of the W unit cells 81) of RIS 50.

A second terminal 87 along a second edge of antenna element 48 (e.g., orthogonal to the first edge of antenna element 48) may be coupled to an adjustable current source such as programmable current source 88 over path 89. Path 89 is sometimes also referred to herein as current path 89 or conductive path 89. Programmable current source 88 may be coupled between path 89 and ground 80. Path 89 may include one or more conductive traces (e.g., in one or more metallization layers of the substrate of RIS 50), one or more conductive vias (e.g., extending through one or more dielectric layers of the substrate of RIS 50), one or more solder balls, and/or other conductive structures in RIS 50.

If desired, a high impedance transmission line segment such as high impedance stub 85 may be disposed on path 89 (e.g., in series between programable current source 88 and terminal 87). If desired, a radial stub 86 may be coupled to a point on path 89 between high impedance stub 85 and programable current source 88. Programmable current source 88, path 89, diode 84H (or diode 84V), high impedance stub 85, and radial stub 86 may collectively form the adjustable device 74 (FIG. 3) for antenna element 48.

In the example of FIG. 4, antenna element 48 is illustrated as a linearly polarized antenna element. In implementations where diode 84H couples terminal 82H to conductor 83, antenna element 48 may be configured to reflect incident wireless signals 46 of a first linear polarization. Alternatively, diode 84H may be replaced with a diode 84V that couples a terminal 82V on a third edge of antenna element 48 to conductor 83 (e.g., where the third edge of antenna element 48 is opposite terminal 87, parallel to the second edge of antenna element 48, and orthogonal to the first edge of antenna element 48). In these implementations, antenna element 48 may be configured to reflect incident wireless signals 46 of a second linear polarization orthogonal to the first linear polarization.

During operation of RIS 50 (e.g., while reflecting incident wireless signals 46), programmable current source 88 may control the flow of current between conductor 83 and terminal 82H on antenna element 48 through diode 84H. At frequencies lower than the frequency of wireless signals 46, the current may also flow between terminal 87 and ground 80 through path 89 and high impedance stub 85. Radial stub 86 may form a low impedance to conductor 83 that is transformed, by high impedance stub 85, into an open circuit at the frequencies of wireless signals 46. This open circuit prevents RF current produced by the incident wireless signals 46 from shorting to ground through path 89 (e.g., decoupling wireless signals 46 from the antenna ground plane).

At the same time, the amount of current flowing through diode 84H causes diode 84H to effectively impart antenna element 48 with a corresponding impedance at the frequencies of wireless signals 46. This impedance causes antenna element 48 to exhibit a corresponding reflection coefficient and causes antenna element 48 to reflect the incident wireless signals 48 with a corresponding phase shift. The phase shifts imparted by each of the W antenna elements 48 across RIS 50 may collectively cause RIS 50 to reflect the incident wireless signals 46 at a corresponding reflection angle Ar (FIG. 3) oriented in a desired direction.

Programmable current source 88 may be switched, controlled, or adjusted using a control signal (e.g., control signal CTRL of FIG. 3) to adjust the impedance of antenna 40 at the frequencies of wireless signals 46 and to adjust the phase shift imparted to wireless signals 46 upon reflection off antenna element 48. In a simplest case, programmable current source 88 may be switched, controlled, or adjusted between a first state and a second state. In the first state, current source 88 is turned on and produces a non-zero current through diode 84H (e.g., diode 84H is turned on by programmable current source 88), which causes antenna element 48 to reflect wireless signals 46 with a first phase shift (e.g., 0 degrees). In the second state, current source 88 is turned off and produces no current through diode 84H (e.g., diode 84H is turned off by programmable current source 88), causing antenna element 48 to reflect wireless signals 46 with a second phase shift that is opposite the first phase shift (e.g., 180 degrees).

This simplest case may allow RIS 50 to reconfigure its antenna elements 48 while consuming minimal resources on RIS 50. For example, RIS 50 may be controlled to switch between different reflected angles Ar for wireless signals 46 by simply turning the diode 84 for different sets of the antenna elements 48 on RIS 50 on or off (e.g., using the control signal CTRL provided to the corresponding programable current sources 88). This may also serve to minimize the cost of RIS 50 while maximizing the scalability of antenna elements 48 and RIS 50. This simplest case is illustrative and non-limiting. In general, programmable current source 88 may be adjusted between any desired number of two or more states to program diode 84H to configure antenna element 48 to impart two or more corresponding phase shifts to the reflected wireless signals 46. A greater number of states (formable phase shifts) may consume more resources and/or may increase the cost of RIS 50 but may also increase the number of reflected angles Ar and/or the precision of the reflected angle Ar produced by RIS 50.

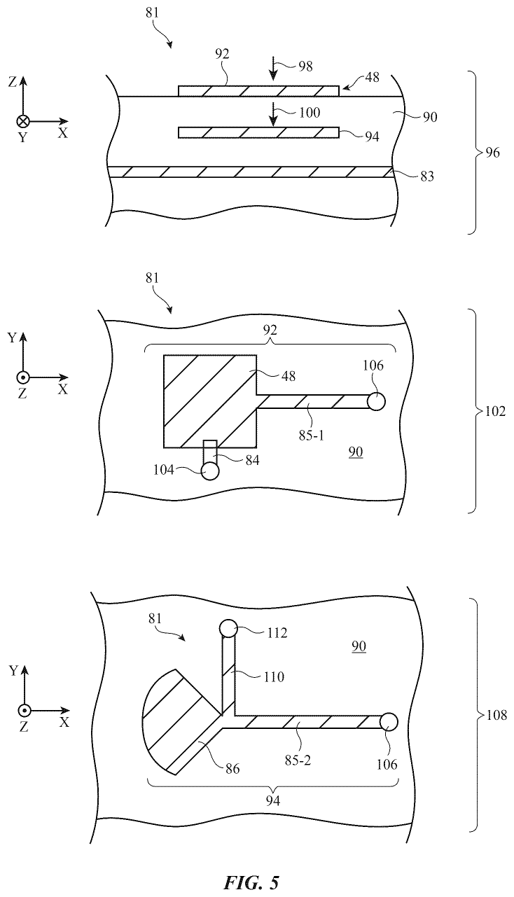

FIG. 5 is a diagram showing one example of how unit cell 81 may be integrated into a substrate for RIS 50. As shown in the cross-sectional side view of portion 96 of FIG. 5, unit cell 81 may be integrated into a substrate such as printed circuit board 90. Printed circuit board 90 may be a rigid or flexible printed circuit board. Printed circuit board 90 may include a stack of interleaved dielectric and metal layers.

Antenna element 48 may be formed from one or more conductive traces 92 in a first (e.g., top) metallization layer of printed circuit board 90. Unit cell 81 may also include one or more conductive traces 94 in a second metallization layer of printed circuit board 90. Conductor 83 may be formed from a third metallization layer of printed circuit board 90 (e.g., a ground layer). One or more conductive vias may couple different metallization layers of unit cell 81 together through printed circuit board 90.

Portion 102 of FIG. 5 is a top view of the conductive trace(s) 92 in unit cell 81 (e.g., as viewed in the direction of arrow 98 in portion 96 of FIG. 5). As shown in portion 102 of FIG. 5, conductive trace(s) 92 may form antenna element 48. Conductive trace(s) 92 may also form a first portion of high impedance stub 85 (FIG. 4), denoted as high impedance stub 85-1. High impedance stub 85-1 may extend from an edge of antenna element 48 (e.g., at terminal 87 of FIG. 4) to a conductive via 106 extending downwards into printed circuit board 90. Diode 84 (e.g., diode 84H or diode 84V of FIG. 4) may be coupled to an orthogonal edge of antenna element 48. Diode 84 may be coupled between antenna element 48 and a conductive via 104 extending downwards into printed circuit board 90. Conductive via 104 may couple diode 84 to conductor 83 through the layers of printed circuit board 90.

Portion 108 of FIG. 5 is a top view of the conductive trace(s) 94 in unit cell 81 (e.g., as viewed in the direction of arrow 100 in portion 96 of FIG. 5). As shown in portion 108 of FIG. 5, conductive trace(s) 94 may form a second portion of high impedance stub 85 (FIG. 4), denoted as high impedance stub 85-2. High impedance stub 85-2 may extend from conductive via 106 to segment 110 of conductive trace(s) 94). Segment 110 may extend from high impedance stub 85-2 to a conductive via 112 that extends further downward into printed circuit board 90 (e.g., to programable current source 88 of FIG. 4). Conductive via 112, segment 110, high impedance stub 85-2, conductive via 106, and high impedance stub 85-1 may collectively form path 89 of FIG. 4. The width of high impedance stubs 85-2 and 85-1 may be selected to configure stubs 85-1 and 85-2 to exhibit a desired high impedance. Conductive trace(s) 94 may also form radial stub 86, extending away from segment 110 and high impedance stub 85-2. The example of FIG. 5 is illustrative and non-limiting. If desired, unit cell 81 may be distributed between more than two metallization layers. Conductive traces 92 and 94 may include any desired number of segments extending in any desired manner.

If desired, the antenna element 48, conductive trace(s) 92, and conductive trace(s) 94 for each unit cell 81 in RIS 50 may be disposed in a first region of printed circuit board 90 whereas the programable current sources 88 for the unit cells are disposed in a second region of printed circuit 90 (e.g., away or offset from antenna elements 48). The first region may be, for example, a central region of printed circuit board 90 whereas the second region is a peripheral region of printed circuit board 90. Put differently, the control overhead for the antenna elements 48 in RIS 50 may be at least partially offloaded to the periphery of printed circuit board 90.

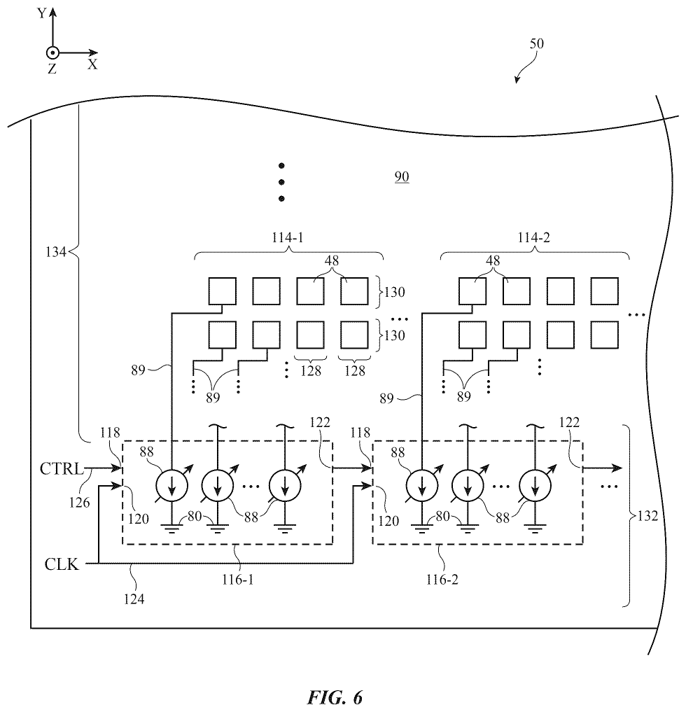

FIG. 6 is a top view showing one example of how the control overhead for the antenna elements 48 in RIS 50 may be offloaded to the periphery of printed circuit board 90. As shown in FIG. 6, printed circuit board 90 may have a first region 134 and may have a second region 132. Region 134 is larger than region 132. Region 134 may include, for example, a central region and/or a majority of the lateral area of printed circuit board 90. Region 132 may be a peripheral region that is interposed between central region 134 and one or more peripheral edges of printed circuit board 90. Region 132 is sometimes referred to herein as peripheral region 132.

The antenna elements 48 of RIS 50 may be disposed within region 134. The programable current sources 88 for antenna elements 48 may be disposed within peripheral region 132. Each programable current source 88 may be coupled to a different respective antenna element 48 in region 134 over a corresponding path 89. Paths 89 may include conductive traces extending from peripheral region 132 to region 134 of printed circuit board 90. Programmable current sources 88 may be coupled between paths 89 and ground 80.

If desired, RIS 50 may include a set of two or more control integrated circuits (ICs) 116. Each control IC 116 may control a different respective set 114 of the antenna elements 48 in region 134. Each set 114 may, for example, be laterally offset from the other sets 114 in RIS 50. For example, RIS 50 may include at least a first control IC 116-1 that controls a first set 114-1 of antenna elements 48 and a second control IC 116-2 that controls a second set 114-2 of antenna elements 48. Control ICs 116 may be surface mounted to printed circuit board 90 within peripheral region 132 (e.g., using solder balls, a ball grid array, etc.). Control ICs 116 are sometimes also referred to herein as control chips 116, controller chips 116, control modules 116, or controller modules 116.

Each control IC 116 may include the programable current sources 88 for its associated set 114 of antenna elements 48. For example, control IC 116-1 may include the programable current sources 88 for each of the antenna elements 48 in set 114-1. The programable current sources 88 in control IC 116-1 may be coupled to the antenna elements 48 in set 114-1 over corresponding paths 89. Similarly, control IC 116-1 may include the current sources 88 for each of the antenna elements 48 in set 114-2. The programable current sources 88 in control IC 116-2 may be coupled to the antenna elements 48 in set 114-2 over corresponding paths 89.

The antenna elements 48 in each set 114 may be arranged in any desired number of one or more rows 130 and one or more columns 128. If desired, each row 130 of antenna elements 48 in a given set 114 may be coupled to the same shared programable current source 88. In these implementations, the shared programable current source 88 may concurrently configure each antenna element 48 in its corresponding row 130 to impart the same phase shift to reflected wireless signals 46 (e.g., the antenna elements 48 in each set 114 may be addressed and configured on a row-by-row basis). Alternatively, if desired, each column 128 of antenna elements 48 in a given set 114 may be coupled to the same shared programable current source 88. In these implementations, the shared programable current source 88 may concurrently configure each antenna element 48 in its corresponding column 128 to impart the same phase shift to reflected wireless signals 46 (e.g., the antenna elements 48 in each set 114 may be addressed and configured on a column-by-column basis). Alternatively, if desired, multiple rows and/or multiple columns of antenna elements 48 in a given set 114 may be coupled to the same shared programable current source 88. In these implementations, the shared programable current source 88 may concurrently configure each antenna element 48 in its multiple rows and/or columns to impart the same phase shift to reflected wireless signals 46 (e.g., the antenna elements 48 in each set 114 may be addressed and configured on a group-by-group basis within set 114). These implementations may, for example, help to minimize power and space consumed by control ICs 116, may help to minimize the routing complexity for paths 89, and/or help to may minimize the area of printed circuit board 90. Alternatively, each antenna element 48 in a given set 114 may be controlled by a different respective programable current source 88 in its associated control IC 116 (e.g., the antenna elements 48 in each set 114 may be addressed and configured on an element-by-element basis) to maximize the flexibility with which RIS 50 reflects wireless signals 46. Antenna elements 48 need not be arranged in rows and columns and may, in general, be arranged in any desired array pattern on printed circuit board 90.

Each control IC 116 has a respective control input 118 that receives control signal CTRL (e.g., from control circuitry 52 of FIG. 3). Each control IC 116 also has a respective clock input 120 that receives a clock signal CLK over clocking path 124 (e.g., from clocking circuitry in control circuitry 52 of FIG. 3 such as a voltage controlled oscillator, a crystal oscillator, a phase-locked loop, a frequency-locked loop, etc.). Each control IC 116 also has a respective control output 122.

Control signal CTRL and clock signal CLK may control the programable current sources 88 in each control IC 116 to configure (or reconfigure) the phase shifts imparted by the antenna elements 48 in its associated set 114. Control signal CTRL and clock signal CLK may, for example, place the programable current sources 88 in each control IC 116 in a selected one of the first or second states (e.g., to configure the associated antenna elements 48 to impart a 0 degree or 180 degree phase shift to reflected wireless signals 46). This is illustrative and, in general, control signal CTRL and clock signal CLK may place (program) the programable current sources 88 in each control IC 116 into a selected state from a set of any desired number of two or more states (e.g., for imparting any desired number of two or more phase shifts) and may adjust, switch, or re-program the programable current sources 88 between the states over time.

To help minimize control routing complexity, control ICs 116 may be daisy chained together on printed circuit board 90 (e.g., using a serial interface). In these implementations, the control input 118 of each control IC 116 may be a serial input port and the control output 122 of each control IC 116 may be a serial output port. The control input 118 of control IC 116-1 may receive control signal CTRL over control path 126, the control output 122 of control IC 116-1 may be coupled to the control input 118 of control IC 116-2, the control output 122 of control IC 116-2 may be coupled to the control input 118 of the next control IC 116 in peripheral region 132, etc. Control IC 116 may transmit control signal CTRL to control IC 116-2 over its control output 122. Control IC 116-2 may receive control signal CTRL from control IC 116-1 over its control input 118. RIS 50 may include any desired number of one or more control ICs 116 and corresponding sets 114 (e.g., a single control IC 116 for a single set 114, three control ICs 116 for three sets 114, more than three control ICs 116 and sets 114, dozens of control ICs 116 and sets 114, hundreds of control ICs 116 and sets 114, etc.).

If desired, each set 114 of antenna elements 48 may include horizontally polarized antenna elements 48 (denoted herein as horizontally polarized antenna elements 48H) and/or vertically polarized antenna elements 48 (denoted herein as vertically polarized antenna elements 48V). In some implementations, region 134 may be divided into two or more sub-regions that each contain only horizontally polarized antenna elements 48H or vertically polarized antenna elements 48V.

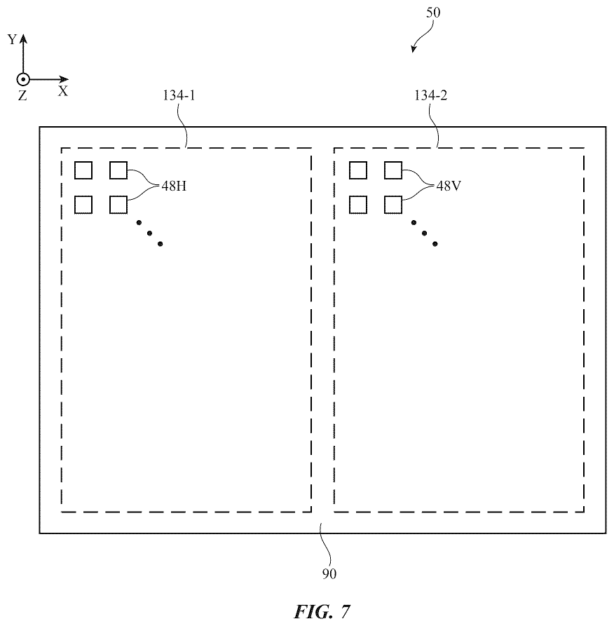

FIG. 7 is a top view showing one example in which a first portion of region 134 includes only horizontally polarized antenna elements 48H and in which a second portion of region 134 includes only vertically polarized antenna elements 48V. As shown in FIG. 7, region 134 may have a first sub-region 134-1 that contains only horizontally polarized antenna elements 48H (e.g., in one or more corresponding sets 114 of FIG. 6) and may have a second sub-region 134-2 that contains only vertically polarized antenna elements 48V. This is illustrative and non-limiting. In general, region 134 may be divided into any desired number of portions, areas, or sub-regions of only vertically polarized antenna elements 48V or only horizontally polarized antenna elements 48H.

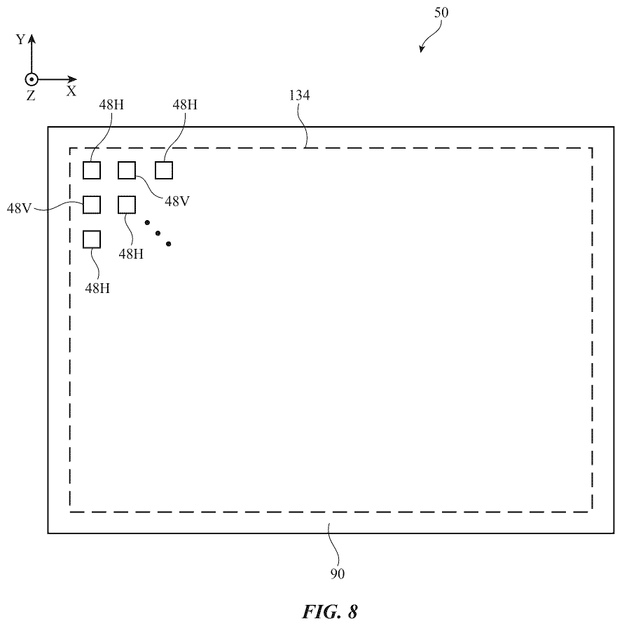

Alternatively, region 134 may include vertically polarized antenna elements 48V that are interleaved with horizontally polarized antenna elements 48V, as shown in the example of FIG. 8. As shown in FIG. 8, each row of antenna elements 48 in region 134 may include alternating (interleaved) horizontally polarized antenna elements 48H and vertically polarized antenna elements 48V. Additionally or alternatively, each column of antenna elements 48 in region 134 may include alternating (interleaved) horizontally polarized antenna elements 48H and vertically polarized antenna elements 48V. Including both horizontally polarized antenna elements 48H and vertically polarized antenna elements 48V in region 134 (e.g., in different respective regions as shown in FIG. 8 or in an interleaved pattern as shown in FIG. 8) may configure RIS 50 to reflect both horizontal and vertical polarizations of incident wireless signals 46.

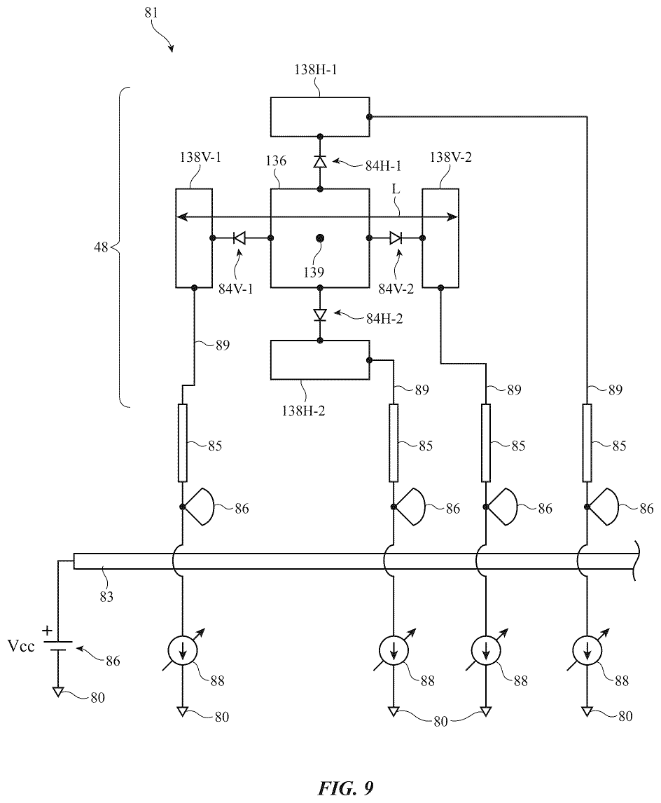

The example of FIGS. 4-8 in which each unit cell 81 includes an antenna element 48 that reflects a single polarization of wireless signals 46 is illustrative and non-limiting. If desired, each unit cell 81 may include a dual-polarized antenna element 48 that concurrently reflects two orthogonal linear polarizations of wireless signals 46 (e.g., both horizontal and vertical polarizations). FIG. 9 is a diagram showing one example of a unit cell 81 that includes a dual-polarized antenna element 48 for reflecting orthogonal linear polarizations of wireless signals 46.

As shown in FIG. 9, antenna element 48 may include multiple conductive patches (patch elements) such as a central patch 136 and a set of peripheral patches 138 that laterally surround central patch 136. A conductive via 139 may couple a point on central patch 136 (e.g., at the center of central patch 136) to conductor 83 and DC voltage source 86. Peripheral patches 138 may include, for example, a first patch 138V-1 laterally separated from the left edge of central patch 136 by a first gap, a second patch 138V-2 laterally separated from the right edge of central patch 136 by a second gap, a third patch 138H-1 laterally separated from the top edge of central patch 136 by a third gap, and a fourth patch 138H-2 laterally separated from the bottom edge of central patch 136 by a fourth gap. Central patch 136 may be rectangular (e.g., square). Patches 138V-1, 138V-2, 138H-1, and 138H-2 may be rectangular patches. This is illustrative and, in general, patches 136, 138V-1, 138V-2, 138H-1, and 138H-2 may have any desired shapes (e.g., having any desired number of straight and/or curved edges). The length L of antenna element 48 may be given by the length of central patch 136 plus the widths of two opposing peripheral patches 138.

Unit cell 81 may include different respective diodes 84 (e.g., PIN diodes) coupled between central patch 136 and each of patches 138V-1, 138V-2, 138H-1, and 138H-2. For example, unit cell 81 may have a first diode 84V-1 coupled between patch 138V-1 and central patch 136 across the first gap. The cathode of diode 84V-1 may be coupled to patch 138V-1 and the anode of diode 84V-1 may be coupled to the left edge of central patch 136. Unit cell 81 may have a second diode 84V-2 coupled between patch 138V-2 and central patch 136 across the second gap. The cathode of diode 84V-2 may be coupled to patch 138V-2 and the anode of diode 84V-2 may be coupled to the right edge of central patch 136. Unit cell 81 may have a third diode 84H-1 coupled between patch 138H-1 and central patch 136 across the third gap. The cathode of diode 84H-1 may be coupled to patch 138H-1 and the anode of diode 84H-1 may be coupled to the top edge of central patch 136. Unit cell 81 may have a fourth diode 84H-2 coupled between patch 138H-2 and central patch 136 across the fourth gap. The cathode of diode 84H-2 may be coupled to patch 138H-2 and the anode of diode 84H-2 may be coupled to the bottom edge of central patch 136.

In the example of FIG. 9, each of patches 138V-1, 138V-2, 138H-1, and 138H-2 is coupled to a different respective programable current source 88 over a different respective path 89. Each path 89 may have a corresponding high impedance stub 85 and a corresponding radial stub 86. Programmable current sources 88 may switch diodes 84V-1 and 84V-2 between at least two different states in which the diodes configure antenna element 48 (e.g., central patch 136, patch 138V-1, and patch 138V-2) to reflect vertically polarized wireless signals 46 with at least two different phase shifts. At the same time, programmable current sources 88 may switch diodes 84H-1 and 84H-2 between at least two different states in which the diodes configure antenna element 48 (e.g., central patch 136, patch 138H-1, and patch 138H-2) to reflect horizontally polarized wireless signals 46 with at least two different phase shifts. If desired, the phase shift imparted to horizontally polarized wireless signals 46 may be controlled independent of the phase shift imparted to vertically polarized wireless signals 46 (e.g., the phase shift imparted to horizontally polarized wireless signals 46 may be different than phase shift imparted to vertically polarized wireless signals 46), helping to maximize the reflection flexibility of RIS 50.

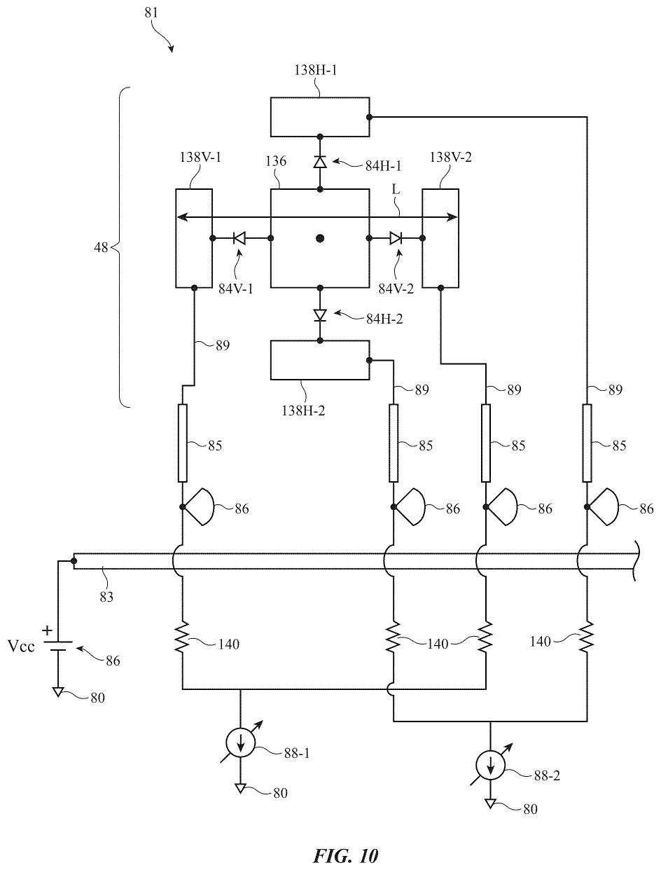

The example of FIG. 9 in which patches 138H-1, 138H-2, 138V-1, and 138V-2 are each coupled to a different respective programmable current source 88 is illustrative and non-limiting. If desired, the horizontally polarized patches may share a single current source and the vertically polarized patches may share a single current source. For example, as shown in FIG. 10, the paths 89 coupled to patches 138V-1 and 138V-2 may be coupled to a first shared programmable current source 88-1 (e.g., for controlling the phase shift imparted by antenna element 48 to horizontally polarized wireless signals 46). The paths 89 coupled to patches 138H-1 and 138H-2 may be coupled to a second shared programmable current source 88-2 (e.g., for controlling the phase shift imparted by antenna element 48 to vertically polarized wireless signals 46). Each path 89 may include a respective ballast resistor 140 coupled between its radial stub 86 and the corresponding programmable current source 88. This may, for example, allow unit cell 81 to impart different phase shifts to different linear polarizations of wireless signals 46 while also reducing the number of programmable current sources 88, helping to reduce power consumption, control routing complexity, and current routing complexity.

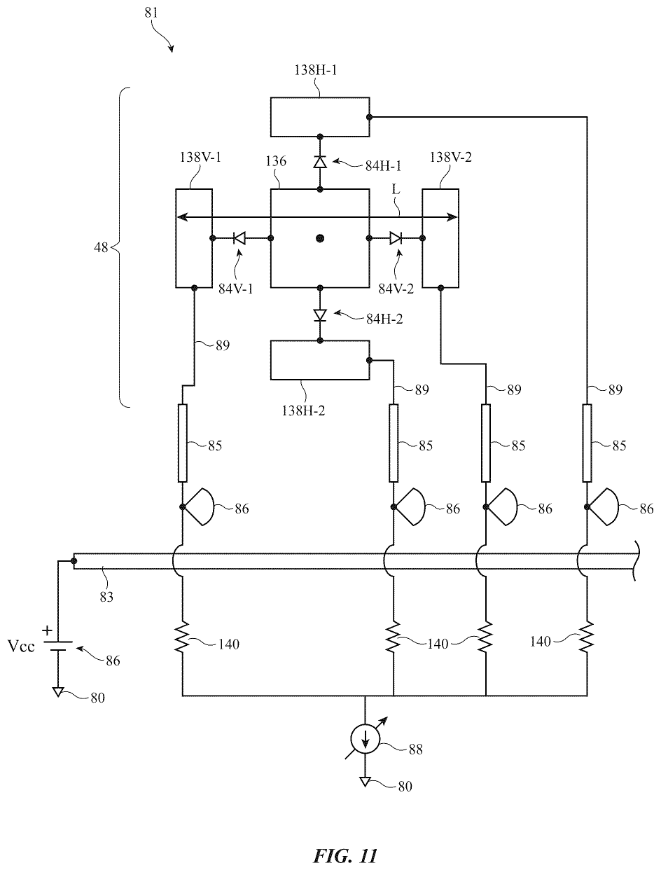

If desired, power consumption, control routing complexity, and current routing complexity may be further reduced by coupling patches 138H-1, 138H-2, 138V-1, and 138V-2 to the same shared programmable current source 88, as shown in the example of FIG. 11. As shown in FIG. 11, each path 89 may include a respective ballast resistor 140 coupled between its radial stub 86 and programmable current source 88. In this example, programmable current source 88 may control diodes 84V-1, 84V-2, 84H-1, and 84H-2 to impart the same phase shift to both polarizations of wireless signals 56.

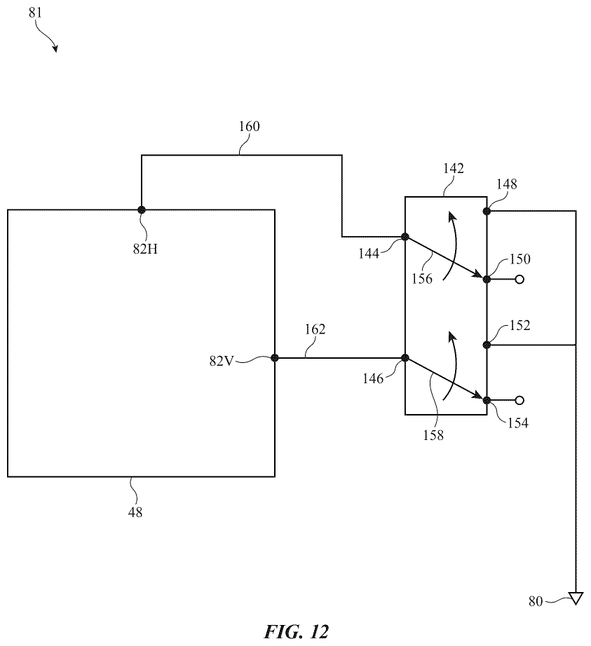

The examples of FIGS. 4-11 in which the adjustable device 74 (FIG. 3) of each unit cell 81 includes at least one diode 84 and at least one programmable current source 88 are illustrative and non-limiting. If desired, the adjustable device 74 of unit cell 81 may include a switch module. FIG. 12 is a schematic diagram of an illustrative antenna unit cell 81 on RIS 50, in implementations where the unit cell is controlled by a switch module.

As shown in FIG. 12, unit cell 81 may include impedance switching circuitry such as switch module 142 (sometimes also referred to herein as impedance switch module 142, impedance switching module 142, impedance switching circuitry 142, switch circuit 142, switching circuitry 142, switchable impedance 142, or switches 142). In implementations where antenna element 48 is a dual-polarization antenna element, switch module 142 may have a first port 144 coupled to terminal 82H on patch element 48 over path 160 and may have a second port 146 coupled to terminal 82V on patch element 48 over path 162. Switch module 142 may include a third port 148 coupled to ground 80, a fourth port 148 that is electrically floating (e.g., coupled to an open circuit impedance), a fifth port 152 coupled to ground 80, and a sixth port 154 that is electrically floating. Ports 144-154 are sometimes also referred to herein as terminals. Ports 148 and 152 are sometimes referred to herein as short circuit ports, short circuit impedance ports, ground ports, or grounded ports. Ports 150 and 154 are sometimes referred to herein as open circuit ports, open circuit impedance ports, or floating ports.

Switch module 142 may include a first switch 156 (e.g., a first single-pole double-throw (SPDT) switch) and a second switch 158 (e.g., a second SPDT switch). Switches 156 and 158 may, for example, be integrated into a dual SPDT (DSPDT) switch module, block, or component. Switch 156 may be controlled, adjusted, or switched between a first state in which switch 156 couples port 144 to port 150 and a second state in which switch 156 couples port 144 to port 148. Switch module 142 may receive a control signal (e.g., control signal CTRL of FIGS. 3 and 6) that sets and/or adjusts the state of switch 156.

In the first state, switch 156 couples an open circuit impedance to terminal 82H of antenna element 48 (through path 160). This may configure antenna element 48 to reflect horizontally polarized wireless signals 46 with a first phase shift (e.g., 0 degrees). In the second state, switch 156 couples a short circuit impedance to terminal 82H (e.g., by coupling terminal 82H to ground 80 over path 160). This may configure antenna element 48 to reflect horizontally polarized wireless signals 46 with a second phase shift (e.g., 180 degrees).

At the same time, switch 158 may be controlled, adjusted, or switched between a first state in which switch 158 couples port 146 to port 154 and a second state in which switch 158 couples port 146 to port 152. Switch module 142 may receive a control signal (e.g., control signal CTRL of FIGS. 3 and 6) that sets and/or adjusts the state of switch 158.

In the first state, switch 158 couples an open circuit impedance to terminal 82V of antenna element 48 (through path 162). This may configure antenna element 48 to reflect vertically polarized wireless signals 46 with the first phase shift (e.g., 0 degrees). In the second state, switch 158 couples a short circuit impedance to terminal 82V (e.g., by coupling terminal 82V to ground 80 over path 162). This may configure antenna element 48 to reflect vertically polarized wireless signals 46 with the second phase shift (e.g., 180 degrees). If desired, switch 156 may be controlled independent of switch 158 (e.g., to configure antenna element 48 to reflect vertically polarized wireless signals 46 and horizontally polarized wireless signals 46 with different phase shifts). Switch module 142 may consume less power than configuring antenna 48 using diode(s) 84 and current source(s) 88, for example.

In implementations where antenna element 48 covers only a single polarization, switch 156 or switch 158 may be omitted from switch module 142. If desired, switch 156 and/or switch 158 may each have more than two switch states (e.g., switch 156 may couple port 144 to at least three ports of switch module 142 and/or switch 158 may couple port 146 to at least three ports of switch module 142).

In these implementations, switch module 142 may include one or more additional ports (not shown for the sake of clarity). Each of the additional ports may be coupled to a different respective load (e.g., a different respective non-zero and non-infinite impedance formed by any desired combination of resistive, capacitive, and/or inductive components). Switch 156 may control antenna element 48 to reflect horizontally polarized wireless signals 46 with a different respective phase shift (e.g., an additional phase shift between 0 degrees and 180 degrees) by coupling port 144 to a corresponding one of the additional ports (e.g., to a corresponding one of the loads coupled to switch module 142). At the same time, switch 158 may control antenna element 48 to reflect vertically polarized wireless signals 46 with a different respective phase shift (e.g., an additional phase shift between 0 degrees and 180 degrees) by coupling port 146 to a corresponding one of the additional ports (e.g., to a corresponding one of the loads coupled to switch module 142). Increasing the number of phase shifts producible by antenna elements 48 in this way may allow for a higher degree of control of the reflected signal beam by the RIS (e.g., reducing the number of sidelobes of the reflected signals and increasing received power by the receiving device, increasing the total number of reflected angles Ar for wireless signals 46, increasing precision of the reflected angles Ar produced by RIS 50, etc.).

In this way, switch module 142 may couple any desired number of different impedances to antenna element 48, configuring antenna element 48 to exhibit any desired number of corresponding complex reflection coefficients and configuring antenna element 48 to reflect wireless signals 46 with any desired number of different phase shifts (e.g., more than two phase shifts). Switch module 142, the loads coupled to the ports of switch module 142 (other than ports 144 and 146), and the path between switch module 142 and ground 80 may collectively form the adjustable device 74 for antenna element 48 (FIG. 3) and are sometimes referred to collectively herein as a reflective phase shifter for antenna element 48. Switch module 142 may be scaled up to any desired number of loads and switch states (e.g., to support a one-bit phase shift, a 2-bit phase shift, or an N-bit phase shift imparted by the antenna element).

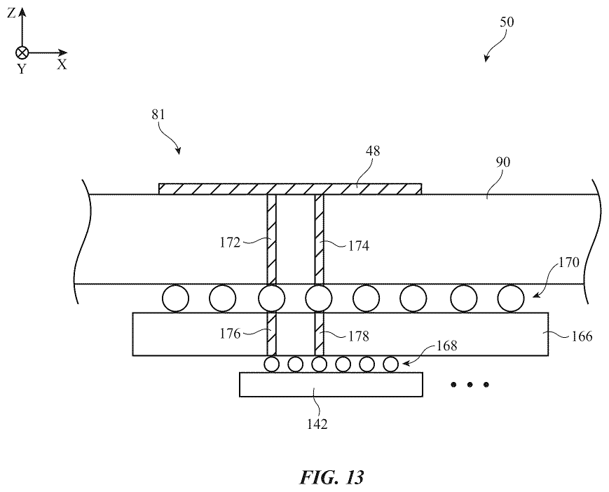

FIG. 13 is a cross-sectional side view showing one example of how unit cell 81 may be distributed between printed circuit board 90 and a reflective phase shifter module mounted to printed circuit board 90. As shown in FIG. 13, an additional module (e.g., integrated circuit chip, substrate, printed circuit, package, etc.) such as reflective phase shifter module 166 may be surface-mounted to printed circuit board 90 (e.g., opposite the antenna elements 48 on RIS 50). Reflective phase shifter module 166 may be coupled to printed circuit board 90 using an array of solder balls 170 or other conductive interconnect structures.

The switch module 142 of unit cell 81 may be surface mounted to reflective phase shifter module 166 opposite printed circuit board 90 (e.g., printed circuit board 90 may be mounted to a first surface of reflective phase shifter module 166 whereas switch module 142 is mounted to a second surface of reflective phase shifter module 166 opposite the first surface). If desired, switch module 142 may overlap antenna element 48 to minimize routing distance between switch module 142 and antenna element 48. Switch module 142 may be coupled to reflective phase shifter module 166 using one or more solder balls 168 or other conductive interconnect structures. Switch module 142 may include a surface-mount DSPDT component, as one example.

Printed circuit board 90 may include conductive vias 172 and 174. Conductive via 172 may couple terminal 82H (FIG. 12) on antenna element 48 to a first solder ball 170 through printed circuit board 90. Conductive via 174 may couple terminal 82V (FIG. 12) on antenna element 48 to a second solder ball 170 through printed circuit board 90. Reflective phase shifter module 166 may include conductive vias 176 and 178. Conductive via 176 may couple the first solder ball 170 to a first solder ball 168 through reflective phase shifter module 166. Conductive via 178 may couple the second solder ball 170 to a second solder ball 168 through reflective phase shifter module 166. A first solder ball 168 may couple conductive via 176 to port 144 of switch module 142 (FIG. 12). A second solder ball 168 may couple conductive via 178 to port 146 of switch module 142 (FIG. 12). In this way, conductive via 172, the first solder ball 170, conductive via 176, and the first solder ball 168 may collectively form path 160 of FIG. 12. Similarly, conductive via 174, the second solder ball 170, conductive via 178, and the second solder ball 168 may collectively form path 162 of FIG. 12.

Ports 148 and 152 of switch module 142 (FIG. 12) may be coupled to ground 80 on printed circuit board 90 through at least a third solder ball 168, one or more additional conductive vias (not shown) in reflective phase shifter module 166, and at least a third solder ball 170. Ports 150 and 154 of switch module 142 (FIG. 12) may, if desired, be coupled to respective fourth and fifth solder balls 168 that are coupled to floating contact pads on the bottom surface of reflective phase shifter module 166. In implementations where switch module 142 includes additional ports that are coupled to additional non-zero and non-infinite loads, the loads may be formed from components (e.g., surface mount components, conductive vias, transmission line segments, stubs, etc.) in or mounted to switch module 142 (e.g., in or on a dielectric substrate of switch module 142), reflective phase shifter module 166, and/or printed circuit board 90.

If desired, RIS 50 may include a different respective switch module 142 for each of its W antenna elements 48. Each of the switch modules 142 may be surface mounted to reflective phase shifter module 166. If desired, the same switch module 142 may be shared by two or more antenna elements 48. Reflective phase shifter module 166 and/or printed circuit board 90 may include control lines (e.g., conductive traces and/or conductive vias) that convey control signals CTRL to switch modules 142 to control the states of switch modules 142. Reflective phase shifter module 166 may help to route control signals CTRL to all of the switch modules 142 and to couple all of the switch modules 142 to corresponding antenna elements 48 without overcrowding the control/routing layers of printed circuit board 90, for example. The example of FIG. 13 is illustrative and non-limiting. Switch modules 142 may be mounted directly to printed circuit board 90 and/or may be implemented using any desired components on RIS 50.

In the examples of FIGS. 1-13, wireless signals 46 are sometimes described as conveying wireless data (e.g., for performing data communications between device 10 and external device 34). This is illustrative and non-limiting. If desired, wireless signals 46 may include wireless power signals (e.g., wireless power that does not convey or carry wireless communications data). The wireless power signals may be transmitted by a wireless power transmitting device (e.g., a wireless device charger) to a corresponding wireless power receiving device. RIS 50 may help to redirect the wireless power signals from the wireless power transmitting device (e.g., external device 34) to the wireless power receiving device (e.g., device 10). The wireless power receiving device may receive the wireless power signals using one or more antennas and may use the received wireless power signals to power one or more components on the wireless power receiving device and/or to charge a battery on the wireless power receiving device. The wireless power receiving device may, for example, include a rectifier that converts the received wireless power signals into a corresponding DC voltage that is used to power one or more components and/or to charge a batter on the wireless power receiving device. In these implementations, RIS 50 may help the wireless power transmitting device to wirelessly charge the wireless power receiving device even when there is no LOS path between the devices (e.g., by reflecting or redirecting the wireless power signals between the wireless power transmitting device and the wireless power receiving device).

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Device 10 and/or external device 34 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-25 may be performed by the components of device 10, RIS 50, and/or external device 34 using software, firmware, and/or hardware (e.g., dedicated circuitry or hardware). Software code for performing these operations may be stored on non-transitory computer readable storage media (e.g., tangible computer readable storage media) stored on one or more of the components of device 10, RIS 50, and/or external device 34. The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10, RIS 50, and/or external device 34. The processing circuitry may include microprocessors, central processing units (CPUs), application-specific integrated circuits with processing circuitry, or other processing circuitry.

The foregoing is merely illustrative and various modifications can be made to the described embodiments. The foregoing embodiments may be implemented individually or in any combination.

What is claimed is:

1. A reconfigurable intelligent surface (RIS) comprising:
an antenna element configured to reflect a radio-frequency signal; and
a switch having a first port coupled to the antenna element, a second port coupled to a first impedance, and a third port coupled to a second impedance different from the first impedance, wherein
the switch has a first state in which the first port is coupled to the second port and has a second state in which the first port is coupled to the third port,
the antenna element is configured to impart the reflected radio-frequency signal with a first phase while the switch is in the first state, and
the antenna element is configured to impart the reflected radio-frequency signal with a second phase while the switch is in the second state.

2. The RIS of claim 1, wherein the second port is coupled to a reference potential, the third port is electrically floating, and the second phase is 180 degrees from the first phase.

3. The RIS of claim 1, wherein the first port of the switch is coupled to a first terminal on the antenna element and the RIS further comprises:
an additional switch having a fourth port coupled to a second terminal on the antenna element, a fifth port coupled to the first impedance, and a sixth port coupled to the second impedance.

4. The RIS of claim 3, wherein the antenna element comprises a patch, the first terminal is coupled to a first edge of the patch, and the second terminal is coupled to a second edge of the patch orthogonal to the first edge of the patch.

5. The RIS of claim 3, wherein the additional switch has a third state in which the fourth port is coupled to the fifth port and has a fourth state in which the fourth port is coupled to the sixth port.

6. The RIS of claim 5, wherein the antenna element is further configured to:
impart a first polarization of the reflected radio-frequency signal with the first phase while the switch is in the first state;
impart the first polarization of the reflected radio-frequency signal with the second phase while the switch is in the second state;
impart a second polarization of the reflected radio-frequency signal with the first phase while the additional switch is in the third state, the second polarization being orthogonal to the first polarization; and
impart the second polarization of the reflected radio-frequency signal with the second phase while the additional switch is in fourth second state.

7. The RIS of claim 3, wherein the antenna element is configured to reflect the radio-frequency signal while the switch is in the first state concurrent with the additional switch being in the fourth state.

8. The RIS of claim 1, further comprising:
a printed circuit board, the antenna element being disposed on the printed circuit board; and
a module that is surface mounted to the printed circuit board, wherein the switch is surface mounted to the module.

9. The RIS of claim 8, further comprising:
an array of antenna elements that includes the antenna element and that is configured to reflect the radio-frequency signal at a reflected angle, wherein the antenna elements in the array are controlled using respective switches from a set of switches that are surface mounted to the module; and
control circuitry configured to control the set of switches to adjust the reflected angle of the radio-frequency signal.

10. The RIS of claim 8, further comprising:
a first conductive via that extends through the printed circuit board and that couples the antenna element to a first solder ball between the printed circuit board and the module;
a second solder ball between the module and the switch, the second solder ball being coupled to the first port of the switch; and
a second conductive via that extends through the module and that couples the first solder ball to the second solder ball.

11. The RIS of claim 10, further comprising a third solder ball that couples the third port of the switch to an electrically floating contact pad on the module.

12. The RIS of claim 1, wherein the switch has a fourth port coupled to a non-zero and non-infinite load, the switch having a third state in which the first port is coupled to the fourth port, and the antenna being configured to impart the reflected radio-frequency signal with a third phase while the switch is in the third state.

13. An electronic device comprising:
a substrate;
first and second sets of diodes on the substrate;
an array of antenna elements configured to reflect a radio-frequency signal, wherein the array includes first and second sets of antenna elements in a first region of the substrate;
a first integrated circuit (IC) mounted to a second region of the substrate, wherein the first IC includes first programmable current sources coupled to the first set of antenna elements and configured to control current flow through the first set of diodes; and
a second IC mounted to the second region of the substrate, wherein the second IC includes second programmable current sources coupled to the second set of antenna elements and configured to control current flow through the second set of diodes.

14. The electronic device of claim 13, the first set of antenna elements being arranged in a first set of rows or columns of the array, the second set of antenna elements being arranged in a second set of rows or columns of the array.

15. The electronic device of claim 13, wherein the first IC has a first serial input port and a serial output port, the second IC having a second serial input port coupled to the serial output port of the first IC.

16. The electronic device of claim 15, wherein the first IC has a serial input port configured to receive a control signal, the first IC is configured to adjust the first programmable current sources based on the control signal, the first IC is configured to convey the control signal to the second IC through the serial output port, and the second IC is configured to adjust the second programmable current sources based on the control signal.

17. The electronic device of claim 13, wherein the second region is smaller than the first region and is laterally interposed between the first region and a peripheral edge of the substrate.

18. The electronic device of claim 13, further comprising:
a conductor in the substrate;
a direct current (DC) voltage source coupled between the conductor and a reference potential, the first set of diodes being coupled between first edges of the first set of antenna elements and the conductor; and
signal paths that couple the first programmable current sources to second edges of the first set of antenna elements, the second edges being orthogonal to the first edges.

19. An electronic device comprising:
a passive antenna element configured to reflect a radio-frequency signal and including a first patch, a second patch, a third patch, a first diode couple between a first edge of the first patch and the second patch, and a second diode coupled between a second edge of the first patch and the third patch, the second edge being orthogonal to the first edge; and
one or more programmable current sources coupled to the second patch over a first path and coupled to the third patch over a second path, the one or more programmable current sources being configured to adjust first and second phases imparted to respective first and second polarizations of the reflected radio-frequency signal.

20. The electronic device of claim 19, further comprising:
a conductor;
a direct current (DC) voltage source coupled between the conductor and a reference potential, wherein the passive antenna element further includes
a fourth patch,
a fifth patch,
a third diode coupled between a third edge of the first patch and the fourth patch, the third edge being parallel to the first edge, and
a fourth diode coupled between a fourth edge of the first patch and the fifth patch, the fourth edge being parallel to the second edge;
a third path that couples the one or more programmable current sources to the fourth patch; and
a fourth path that couples the one or more programmable current sources to the fifth patch.
